(19) United States
(12) Patent Application Publication
(10) Pub. No.: US 2024/0109772 A1
(43) Pub. Date: Apr. 4, 2024

(54) Hydrogen Production by Sulfur Steam Reforming

(71) Applicant: Saudi Arabian Oil Company, Dhahran (SA)

(72) Inventors: Guillaume Robert Jean-Francois Raynel, Dhahran (SA); Sebastien A. Duval, Dhahran (SA); Jose Choy Pernia, Dhahran (SA)

(21) Appl. No.: 17/946,413

(22) Filed: Sep. 16, 2022

(51) Int. Cl. C01B 3/06; B01D 53/00; B01D 53/14; B01D 53/26; B01D 53/86; B01J 19/00; B01J 19/24; C01B 3/50; C01B 3/52

(52) U.S. Cl. CPC C01B 3/06; B01D 53/002; B01D 53/1468; B01D 53/1481; B01D 53/265; B01D 53/8615; B01J 19/0013; B01J 19/245; B01J 19/2465; C01B 3/506; C01B 3/52; B01D 2252/103; B01D 2252/204; B01J 2219/00157; C01B 2203/0415; C01B 2203/046; C01B 2203/0485; C01B 2203/148

(57) ABSTRACT

A system and method for producing hydrogen, including steam reforming elemental sulfur to generate hydrogen gas and sulfur dioxide, to give a mixture including hydrogen gas, sulfur dioxide, elemental sulfur gas, and water vapor, removing the elemental sulfur gas to give a process gas including the hydrogen gas, sulfur dioxide, and water vapor, and isolating the hydrogen gas or a hydrogen gas rich stream.

### TECHNICAL FIELD

This disclosure relates to producing hydrogen from sulfur vapor and water.

### BACKGROUND

Hydrogen sulfide can be a byproduct of processing natural gas and refining sulfur-containing crude oils. Other industrial sources of hydrogen sulfide may include pulp and paper manufacturing, chemical production, waste disposal, and so forth. In certain instances, hydrogen sulfide can be considered a precursor to elemental sulfur.

Sulfur recovery may refer to conversion of hydrogen sulfide (H₂S) to elemental sulfur, such as in a sulfur recovery unit (SRU), e.g., Claus system. The most prevalent technique of sulfur recovery is the Claus system, which may be labeled as the Claus process, Claus plant, Claus unit, and the like. The Claus system includes a thermal reactor (e.g., a furnace) and multiple catalytic reactors to convert H₂S into elemental sulfur that is removed (recovered).

Hydrogen is commercially produced, such as from fossil fuels. Hydrogen may be produced, for example, through reforming of hydrocarbons or electrolysis of water. Hydrogen is produced by coal gasification, biomass gasification, water electrolysis, or the reforming or partial oxidation of natural gas or other hydrocarbons.

The reforming of natural gas is the most prevalent source of hydrogen production. Bulk hydrogen is typically produced by the steam reforming of natural gas (methane). Conventional steam reforming includes heating the natural gas (e.g., to between 700° C. to 1100° C.) in the presence of steam and a nickel catalyst. This endothermic reaction generates carbon monoxide and hydrogen. The carbon monoxide gas can be subjected to a water-gas shift reaction to obtain additional hydrogen.

The produced hydrogen can be a feedstock to chemical processes, such as ammonia production, aromatization, hydrodesulfurization, and the hydrogenation or hydrocracking of hydrocarbons. The produced hydrogen can be a feedstock to electrochemical processes, such as fuel cells.

### SUMMARY

An aspect relates a method of producing hydrogen, including steam reforming elemental sulfur from a sulfur pit, thereby generating hydrogen gas and sulfur dioxide, to give a mixture including hydrogen gas, sulfur dioxide, elemental sulfur gas, and water vapor. The method includes condensing elemental sulfur gas in the mixture in a condenser (heat exchanger) into liquid elemental sulfur and discharging liquid elemental sulfur from the condenser to the sulfur pit. The method includes discharging a process gas from the condenser, wherein the process gas includes hydrogen gas and sulfur dioxide generated in the steam reforming.

Another aspect relates to a hydrogen production system including a vessel configured to receive elemental sulfur from a sulfur pit and steam reform the elemental sulfur into hydrogen gas and sulfur dioxide, and discharge a mixture having hydrogen gas, sulfur dioxide, elemental sulfur gas, and water vapor. The hydrogen production system includes a condenser heat exchanger to receive the mixture and condense elemental sulfur gas in the mixture into liquid elemental sulfur, and discharge liquid elemental sulfur to the sulfur pit and discharge a process gas having hydrogen gas and sulfur dioxide generated via steam reforming in the vessel.

The details of one or more implementations are set forth in the accompanying drawings and the description below. Other features and advantages will be apparent from the description and drawings, and from the claims.

### BRIEF DESCRIPTION OF DRAWINGS

FIG. 1 is a plot of change in Gibbs free energy as a function of temperature.

FIG. 2 is a diagram of forward reactions.

FIG. 3 is a diagram of backward reactions.

FIG. 4 is a diagram of valid reactions.

FIG. 5 is a diagram of reactions in the reductive environment (excess hydrogen sulfide) and in which sulfur dioxide is consumed at temperatures less than 445° C.

FIG. 6 is a diagram of an overall reaction in the oxidative environment (excess sulfur dioxide), and is a sulfur steam reforming reaction.

FIGS. 7A-14 are diagrams of hydrogen production systems.

FIG. 15 is a block flow diagram of a method of producing hydrogen.

FIG. 16 is a diagram of a gas sweetening system that is a selective amine process.

### DETAILED DESCRIPTION

Produced hydrogen gas (H₂) can be utilized in the transportation and energy sectors, as well as a feedstock to chemical processes, and the like. Embodiments herein can provide H₂ for these uses (and other uses) by the conversion of elemental S (and water) into H₂ in a sulfur recovery plant or sulfur recovery unit (SRU).

Aspects of the present disclosure are directed to producing hydrogen (H₂) from elemental sulfur (S) and water (H₂O) to generate H₂. In particular, S and H₂O may be contacted at temperature above the boiling point (445° C.) of S to produce H₂ and sulfur dioxide (SO₂). The reaction can be characterized as sulfur steam reforming. The reaction may be or include 2H₂O+S→2H₂+SO₂.

Again, this may be characterized as steam reforming of S. The steam reforming of S may be performed in a Claus furnace (or Claus-type furnace), or in a sulfur steam reformer vessel. The generated H₂ in the discharge gas from the Claus furnace or from the sulfur steam reformer can be recovered as product.

For a Claus furnace (reaction furnace), such steam reforming of the S may be performed in an intermediate zone of the Claus furnace. In this case, the intermediate (e.g., 2^{nd}) zone of the Claus furnace may be labeled as a sulfur steam reformer. The Claus reaction 2H₂S+SO₂→3S+2H₂O may also occur in the Claus furnace in the boiler section as the temperature decreases.

The sulfur steam reforming (whether in the Claus furnace intermediate zone or in a sulfur steam reformer) may be performed in a reductive environment (excess H₂S) or in an oxidative environment (excess SO₂).

As used herein in this context, the reductive environment is evident with an excess H₂S (not an excess SO₂) in the exhaust gas stream, such as with respect to the Claus reaction and any oxidation reactions (e.g., 2H₂S+3O₂→2SO₂+2H₂O) that may occur. The SO₂ (including SO₂ generated in the sulfur steam reforming) may be converted into elemental sulfur with an excess of H₂S. The oxidative environment is evident with an excess SO₂ (not an excess H₂S) with respect to the Claus reaction. Excess SO₂ may be promoted by the sulfur steam reforming.

The range of temperature for the sulfur steam reforming to operate may be, for example, between 445° C. (sulfur boiling point) and 720° C. (sulfur disproportionation into disulfur). The Claus reaction may occur below 445° C. The Claus reaction (Rx 4 below) can be avoided (removed) by maintaining the temperature above 445° C. Thus, the Claus reaction generally does not occur in the sulfur steam reformer operating at a temperature in the range of 500° C. to 600° C. Sulfur steam reforming will generally occur above 445° C. The formation of disulfur at 720° C. may be an unwanted side reaction. Therefore, a beneficial range of operating temperature for the sulfur steam reforming may be between 445° C. and 720° C., such as an operating temperature range of 500° C. to 600° C.

The Claus reaction may occur in a Claus furnace (e.g., and in which the Claus furnace has an intermediate zone performing sulfur steam reforming), and in a stand-alone sulfur steam reformer (not a Claus furnace) in a reductive environment

If excess hydrogen sulfide (H₂S) is fed to the first zone (combustion) of the Claus furnace, excess H₂S may be present in the intermediate zone giving a reductive environment in the intermediate zone. In this case, the furnace exhaust gas may be passed over catalytic converters, such as in a Claus system. Again, H₂ gas generated in sulfur steam reforming in the furnace can be recovered.

For the intermediate zone (reaction zone) and discharge zone (e.g., heat exchanger as boiler) of the Claus furnace having excess H₂S giving the reductive environment, S may be condensed and removed from the furnace exhaust gas, and the remaining furnace exhaust gas (having H₂, H₂S, and SO₂) passed over catalytic converters to give S (condensed and removed via associated condensers) and a H₂-rich gas.

In the catalytic converters, the H₂S and the SO₂ react in the Claus reaction to give S and H₂O vapor. As indicated, any S vapor is condensed and removed as liquid S via condensers associated with the catalytic converters. The remaining gas mixture including H₂O vapor, H₂, carbon dioxide (CO₂), any nitrogen (N₂), and residual H₂S discharged from the final catalytic converter (after condensation and removal of S in the final condenser) may be characterized as Claus tail gas but having a significant amount of H₂. This Claus tail gas is forwarded for further processing, e.g., water quenching to remove the H₂O vapor and gas sweetening (such as selective amine treatment) to remove H₂S, and thus a H₂-rich gas having the H₂ product is recovered.

If H₂S is sub-stoichiometric (an oxidative environment) in the Claus furnace intermediate zone, an excess of SO₂ may be generated. In this case, downstream catalytic converters are not employed. A H₂-rich gas may be separated from the furnace exhaust gas by quenching the exhaust gas with chilled acidic water, which can absorb a relatively large quantity of SO₂ to remove SO₂; and therefore, to give the resulting H₂-rich gas. For the intermediate zone and discharge zone of the Claus-type furnace as sub-stoichiometric H₂S (an oxidative environment) with excess SO₂, the H₂-rich gas may be separated from the furnace exhaust (discharge) gas by quenching the exhaust gas with chilled acidic water to absorb SO₂ from the furnace exhaust gas into the chilled water, leaving a H₂-rich gas. Catalytic converters are not employed. The formed sulfurous acid (water having absorbed SO₂) may be oxidized in an oxidation tower utilizing oxygen from air to give sulfuric acid. The water exiting this oxidation tower may be routed to a water treatment unit(s), such as reverse osmosis (RO) or electrodialysis, distillation, to recover and concentrate the sulfuric acid. Clean water may be reused. Concentrated sulfuric acid can be monetized or injected into the furnace to enrich the furnace combustion in oxygen.

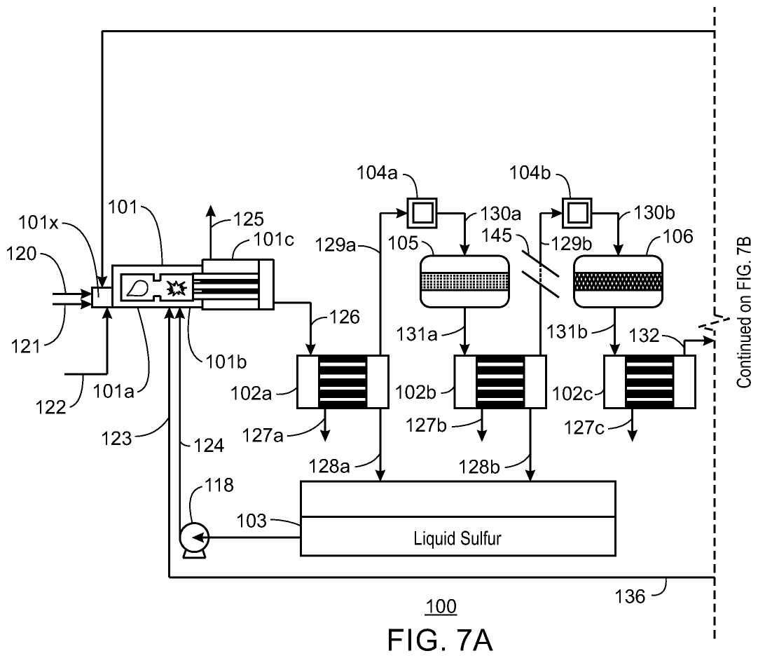

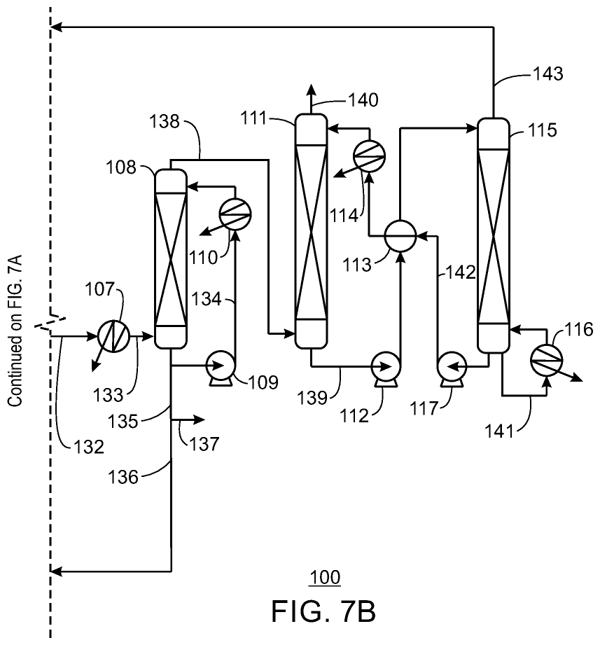

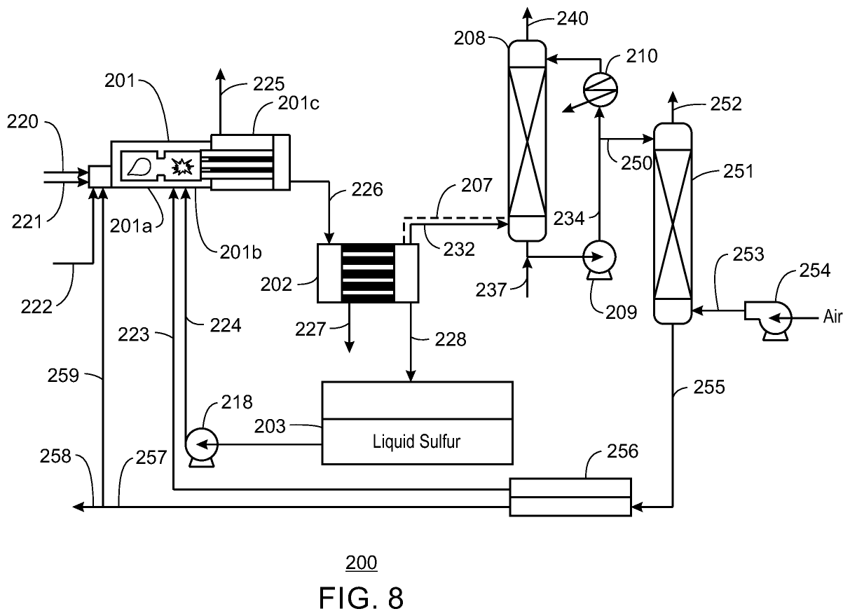

For implementations of acid gas (having H₂S as an acid gas) (whether the H₂S is excess or sub-stoichiometric) fed to a furnace (e.g., Claus furnace), an oxidation reaction in the furnace (e.g., reaction furnace or thermal reactor in thermal stage of Claus system) is 2H₂S+3O₂→2SO₂+2H₂O, which is the oxidation of the entering H₂S from the fed acid gas with fed oxygen (O₂) gas to give SO₂ and H₂O vapor. The reaction furnace as a thermal reactor may also perform the Claus reaction 2H₂S+SO₂→3S+2H₂O, in which H₂S gas and SO₂ react to give elemental S gas and H₂O vapor. An overall reaction involving these two reactions (oxidation reaction and Claus reaction) may be characterized as 2H₂S+O₂→2S+2H₂O. In addition, in accordance with embodiments herein of the present techniques, liquid elemental S and water may be fed (externally injected) into an intermediate zone (e.g., second zone) of the furnace (see, e.g., FIGS. 7A and 8), and in which the intermediate zone acts as a steam reformer of elemental S. As mentioned, a reaction in the steam reforming of S may be, for example, 2H₂O+S→2H₂+SO₂. The generated H₂ may be recovered downstream as product, and thus the system labeled as a hydrogen production system. Lastly, the Claus reaction 2H₂S+SO₂→3S+2H₂O may also be performed (as a catalytic reaction) in Claus catalytic converters (catalytic reactors) if employed to receive the discharged furnace gas.

Reactions for the production of hydrogen in a conventional Claus reaction furnace that have been explored include the following:

Partial methane combustion followed by water-gas shift reaction of carbon monoxide:

3O₂+2CH₄ [symbol] 4H₂O+2CO

H₂O+CO [symbol] H₂+CO₂

Partial H₂S combustion followed by water-gas shift reaction of sulfur monoxide:

O₂+H₂S [symbol] H₂O+SO

H₂O+SO [symbol] H₂+SO₂

Methane steam reforming:

2H₂O+CH₄ [symbol] 4H₂+CO₂

Although the H₂S steam reforming is thermodynamically not allowed in the range of operation temperature of a Claus furnace (T<2000° K), the sulfur steam reforming may be thermodynamically allowed at a temperature above boiling point of sulfur (445° C. or 718.15° K), as depicted below:

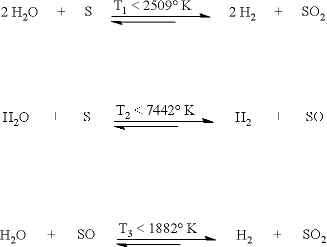

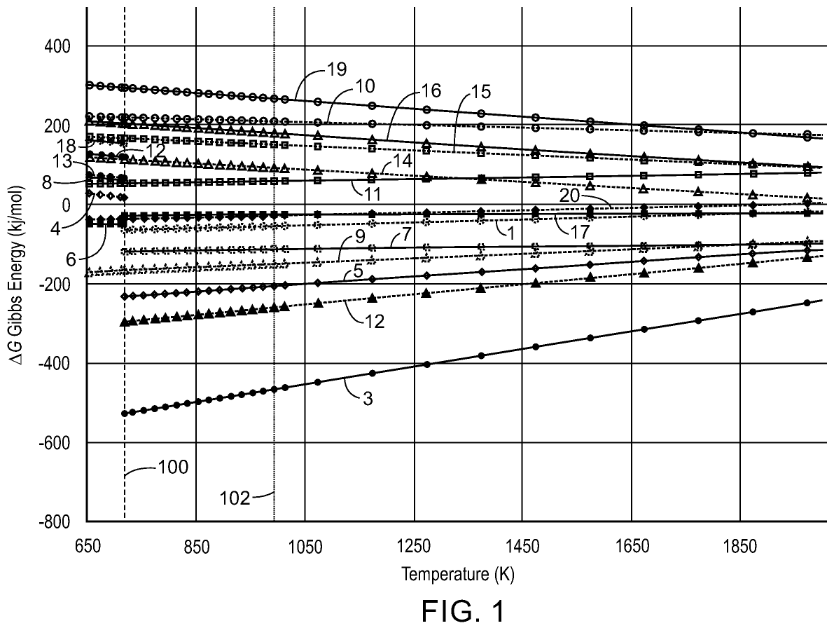

The temperatures, indicated on the reaction schemes above, relate to the temperature at which the reaction inverses. To appreciate the potential disruptive effect the other reactions including side-reactions, the Gibbs free energy of these reactions were calculated as a function of temperature using the enthalpy and entropy of formation given by NIST (National Institute of Standards and Technology). The results are represented on FIG. 1.

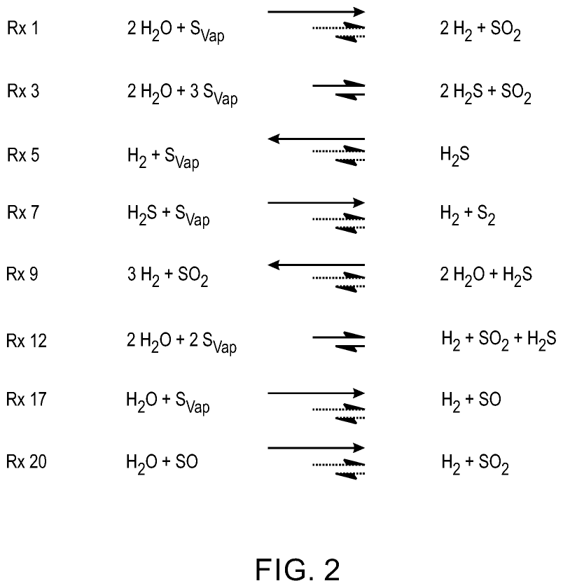

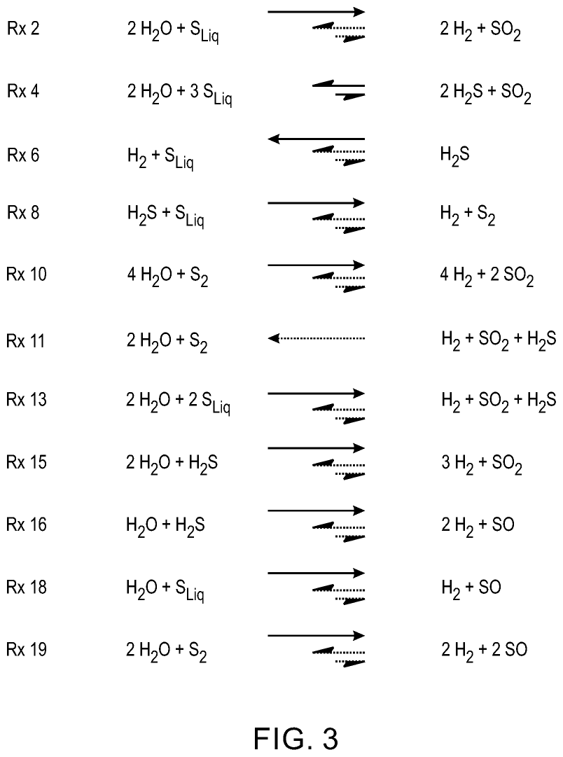

FIG. 1 is a plot of ΔG (the change in Gibbs free energy) in kilojoules per mole (kJ/mol) as a function of temperature in Kelvin (K). A line for each reaction (Rx 1-20) depicted in FIGS. 2-3 is plotted. The vertical dashed line 100 is the vaporization temperature (boiling point) for elemental sulfur. The vertical dashed line 102 is the temperature at which the vapor sulfur dissociates into disulfur S₂. This graph indicates if the reaction at a given temperature is an equilibrium or not an equilibrium (0≠ΔG ∀T), and if going forward (0<ΔG and [symbol] ), or backward (0>ΔG and [symbol] ), where ΔG is the change in Gibbs free energy, T is temperature in Kelvin, and ∀ is the mathematical symbol for “For all . . . ” FIG. 1 is the change in Gibbs energy (Gibbs free energy) of considered reactions as a function of temperature.

FIG. 2 depicts forward reactions considered. FIG. 3 depicts backward reactions considered.

Reactions considered are equilibrium except for reaction Rx 11, which is not an equilibrium. Another aspect is that the hydrogen molecule is generally unreactive in the temperature window (T<4412° K), except, for example, if a metallic catalyzer is introduced. In other words, hydrogen in the operational temperature typically is not a reactant, as the hydrogen generally will not be consumed during the reactions. Therefore, reaction Rx 11 will not occur (e.g., as long as there is not metallic catalyzers, such as platinum (Pt), nickel (Ni), etc.). Similarly, the reaction Rx 5 and Rx 9 generally will not occur without a metallic catalyzer.

The equilibriums can be further driven by adding an excess of one or more of the constituents. It was identified that an excess of H₂O vapor and H₂S displaces the reactions in a desired way (plain arrows), except for reaction Rx 4 (the Claus reaction). This reaction (Rx 4) can be avoided by maintaining the temperature above 445° C. (718° K). By keeping the temperature above 718° K, the following reactions are generally removed as possible reactions: Rx 2, Rx 4, Rx6, Rx 8, Rx13 and Rx 18.

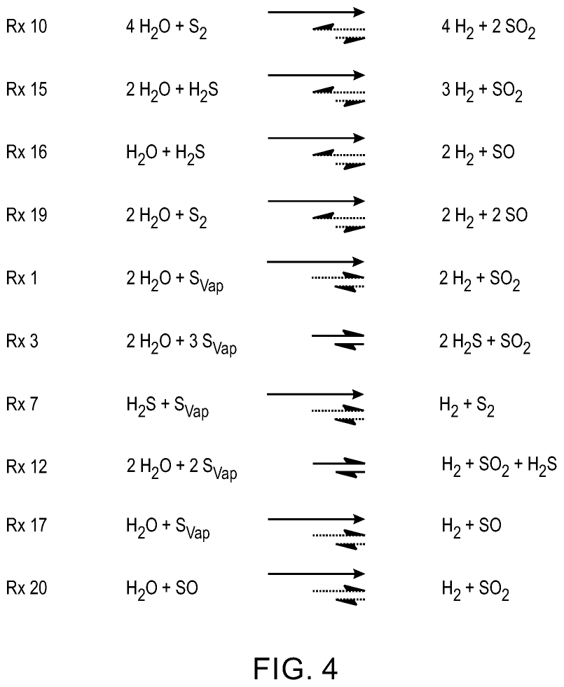

FIG. 4 depicts valid reactions considered. In other words, depicted is a valid set of reactions (or a valid reaction set). In this context, “valid” means the reaction will occur, whereas “invalid” means the reaction will not occur.

The chemistry may drive the separation and heating strategies. Techniques (including systems and processes) are described below as a function of or correlative with the heating approach and the subsequent separation techniques. There are various heating configurations, as discussed below.

Furthermore, there are at least two environments in the Claus furnace (e.g., in a second zone of the furnace) or in the sulfur steam reformer, and in the discharge gas from the furnace or the sulfur steam reformer, that may drive the downstream configuration. As discussed, these two environments or chemical types may be a “reductive” environment or an “oxidative” environment.

A reductive environment for the Claus furnace (e.g., in intermediate zone, second zone, and discharge zone) has an excess of H₂S, such as excess H₂S in the second zone of the Claus furnace or Claus-type furnace. Sulfur dioxide is consumed at low temperature (e.g., less than 445° C.). Again, a “reductive” environment can be excessive H₂S in the second zone of the furnace. If an excess of H₂S is fed to the furnace (giving the reductive environment), the exhaust gases having H₂S may be passed over a downstream catalytic converter(s) to give molten sulfur and a H₂-rich gas. For the reductive environment, the exhaust gas has H₂S (considered as excess H₂S). As mentioned, the furnace gas may be sent across catalytic converter(s) for the Claus reaction. With the reductive environment, the furnace gas discharged having H₂S also has SO₂ (not considered excess SO₂). The sulfur steam reforming in the furnace generates SO₂ that converts in downstream catalytic converters to liquid sulfur with an excess of H₂S.

In an oxidative environment in the furnace or stand-alone sulfur steam reformer, the furnace intermediate zone (and discharge zone), or the sulfur steam reformer, has an excess of SO₂, with the sulfur steam reforming reaction contributing SO₂. The sulfur steam reforming reaction is performed in the stand-alone sulfur steam reformer and may be performed in the furnace intermediate zone. The furnace discharge gas has H₂S in the excess of SO₂ in the furnace discharge gas. If H₂S is sub-stoichiometric (not in excess) in the furnace, an excess of SO₂ (an oxidative environment) may be generated in the furnace (e.g., second zone) and for the exhaust gas. In this case, H₂-rich gas may be separated from the exhaust gas by quenching the exhaust gas with chilled acidic water, which can absorb a relatively large quantity of SO₂. The formed sulfurous acid (a hydrated formed of SO₂) may be oxidized in a subsequent oxidation tower utilizing oxygen from air to give sulfuric acid.

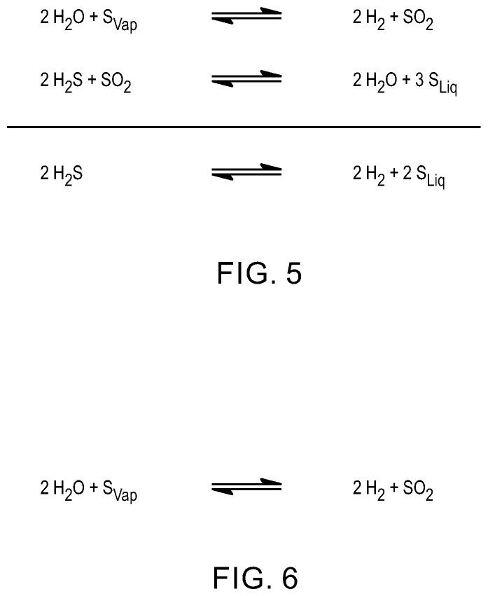

FIG. 5 gives reactions in the reductive environment (having excess of H₂S) and in which SO₂ is consumed at temperatures less than 445° C. The first reaction depicted in the sulfur steam reforming reaction. The second reaction depicted is a Claus reaction. The third reaction depicted under the line is the overall reaction in the reductive environment. This overall reaction is the sulfur steam reforming reaction and the Claus reaction, as combined, and appears as the splitting or dissociation of H₂S.

FIG. 6 is a sulfur steam reforming reaction. This reaction produces an oxidative environment due to the formation of SO₂ as a product of the reaction.

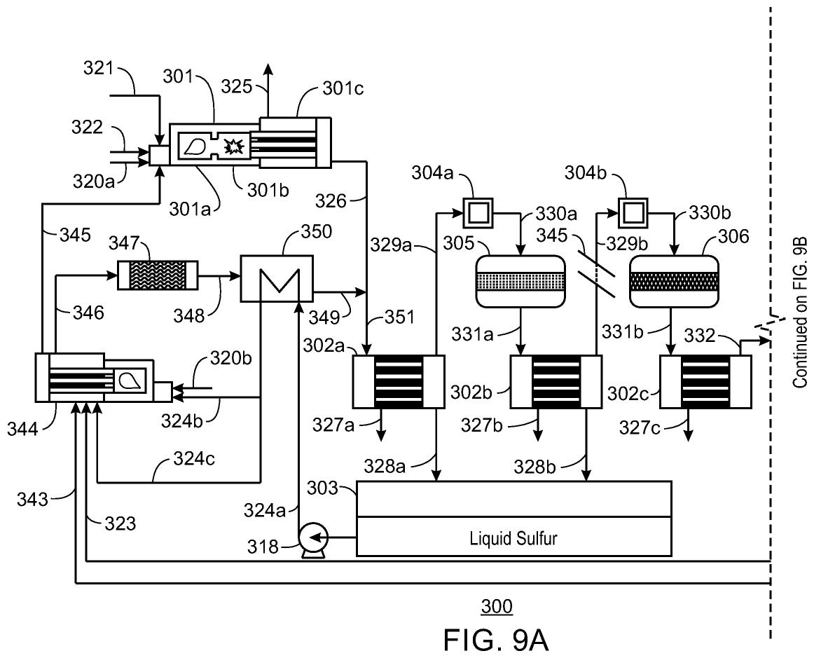

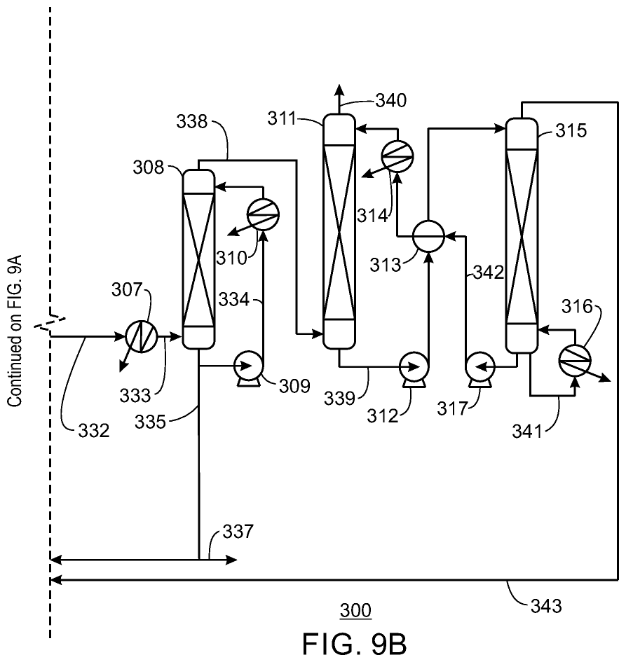

Heating of the elemental sulfur and the water for the sulfur steam reforming can be direct heating (e.g., FIGS. 7A-8) by direct contact of the elemental sulfur and water with combustion gas in a furnace, or indirect heating (e.g., FIGS. 9-14) by heating in a sulfur burner, electric heater, or boiler.

Immediately below is a summary of FIGS. 7A-14. A reductive environment (excess H₂S) or oxidative environment (excess SO₂) is listed. A reductive environment is defined in the context as presence of excess H₂S. An oxidative environment in defined in the context as presence of excess SO₂. Direct heating may be defined herein as the fluid being heated in direct contact with the heating medium (without conduction through an interface). A more detailed description of FIGS. 7A-14 is given further below.

FIGS. 7A and 7B: Direct heating of S and water in reductive environment of Claus furnace 2^{nd} zone by direct contact with furnace gas from Claus furnace 1^{st} zone. The Claus furnace 2^{nd} zone acts as a sulfur steam reformer along with performing the Claus reaction in the heat recovery zone (e.g., boiler).

FIG. 8: Direct heating of S and water in oxidative environment of Claus furnace 2^{nd} zone by direct contact with furnace gas from Claus furnace 1^{st} zone. The Claus furnace 2^{nd} zone acts as a sulfur steam reformer along with performing the Claus reaction in the heat recovery zone (e.g., boiler).

FIGS. 9A and 9B: Indirect heating of S and water (via heating with sulfur burner) for sulfur steam reforming in a sulfur steam reformer separate from the Claus furnace. The Claus furnace 2^{nd} zone has a reductive environment and performs the Claus reaction in the heat recovery zone (e.g., boiler).

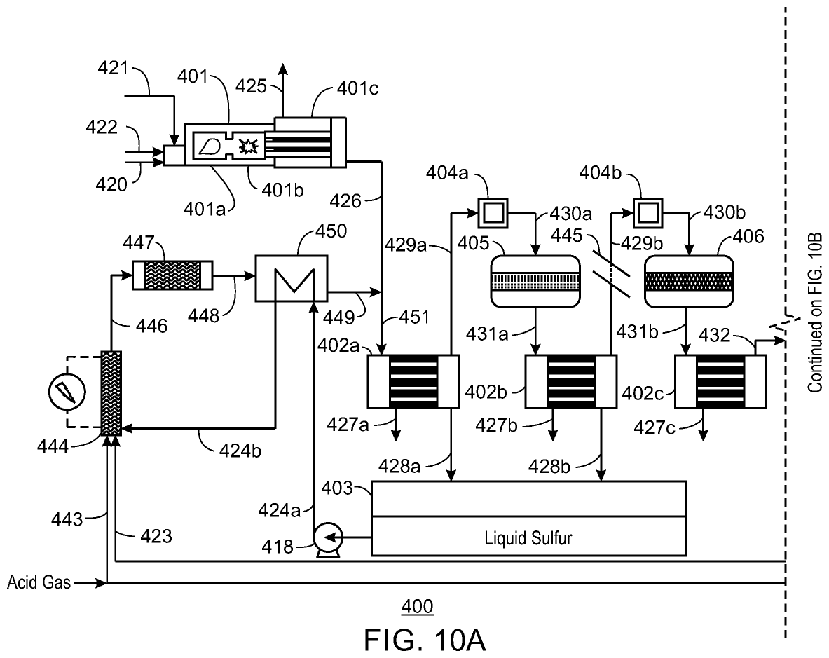

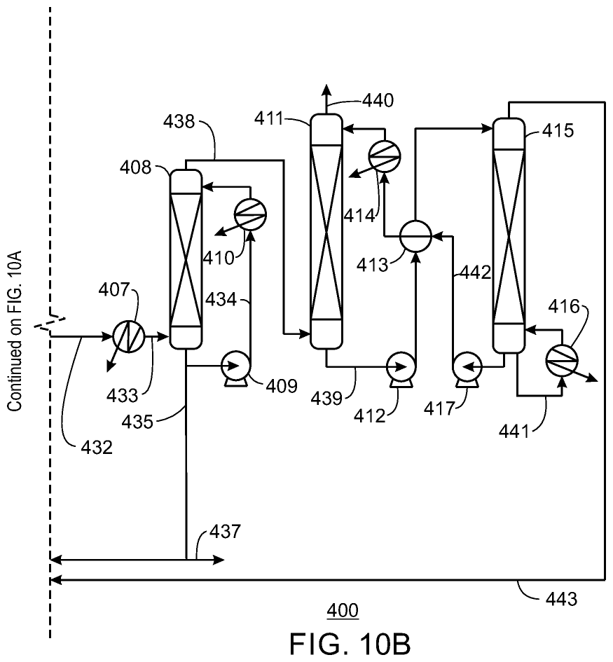

FIGS. 10A and 10B: Indirect heating of S and water (via heating with electric heater or boiler) for sulfur steam reforming in a sulfur steam reformer separate from the Claus furnace. The Claus furnace 2^{nd} zone has a reductive environment and performs the Claus reaction in the heat recovery zone (e.g., boiler).

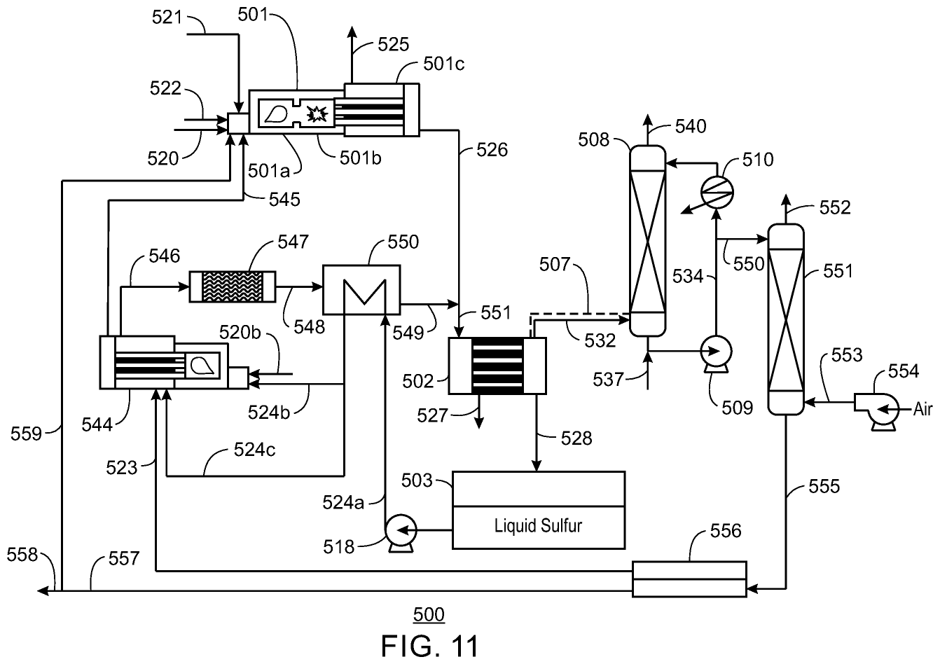

FIG. 11: Indirect heating of S and water (via heating with sulfur burner) for sulfur steam reforming in a sulfur steam reformer separate from the Claus furnace.

The Claus furnace 2^{nd} zone has an oxidative environment and performs the Claus reaction in the heat recovery zone (e.g., boiler).

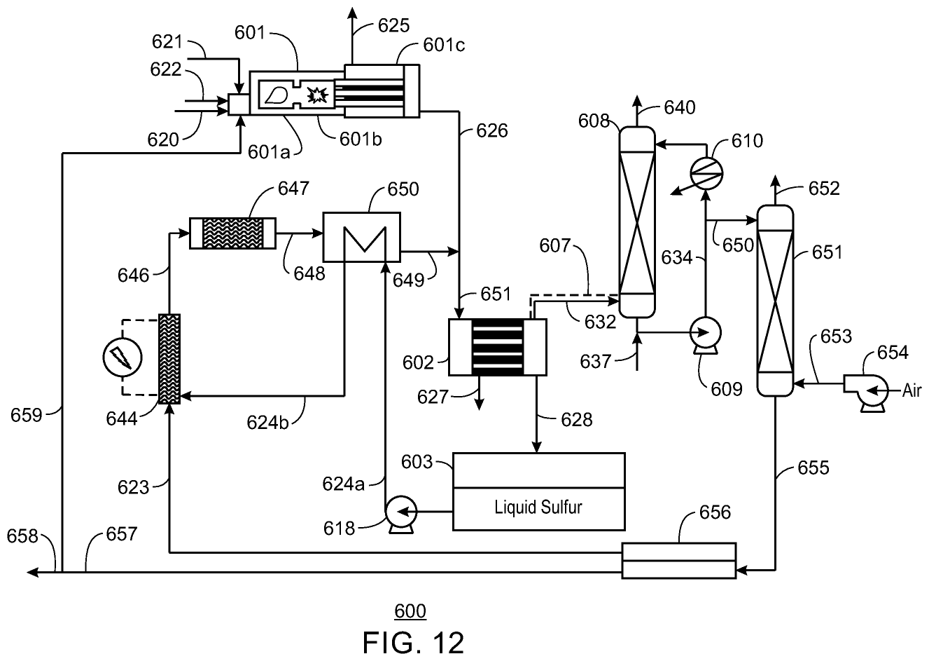

FIG. 12: Indirect heating of S and water (via heating with electric heater or boiler) for sulfur steam reforming in a sulfur steam reformer separate from the Claus furnace. The Claus furnace 2^{nd} zone has an oxidative environment and performs the Claus reaction in the heat recovery zone (e.g., boiler). The heating of the fluid in the electric heater is indirect heating.

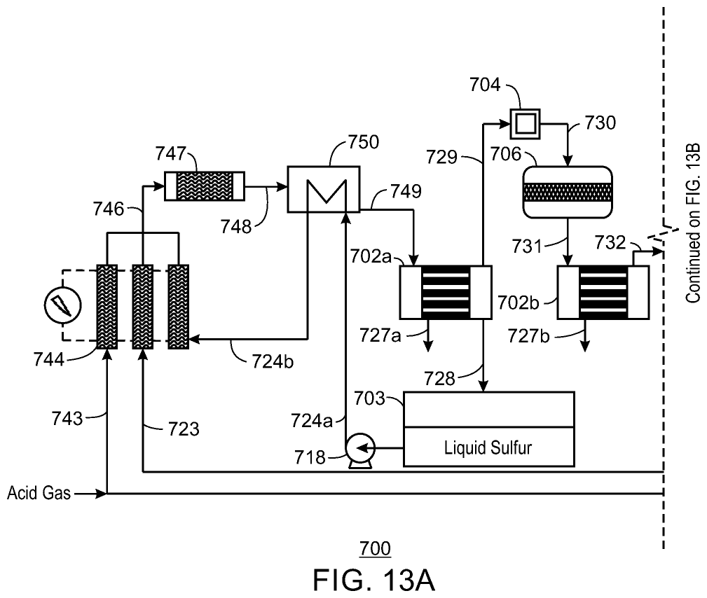

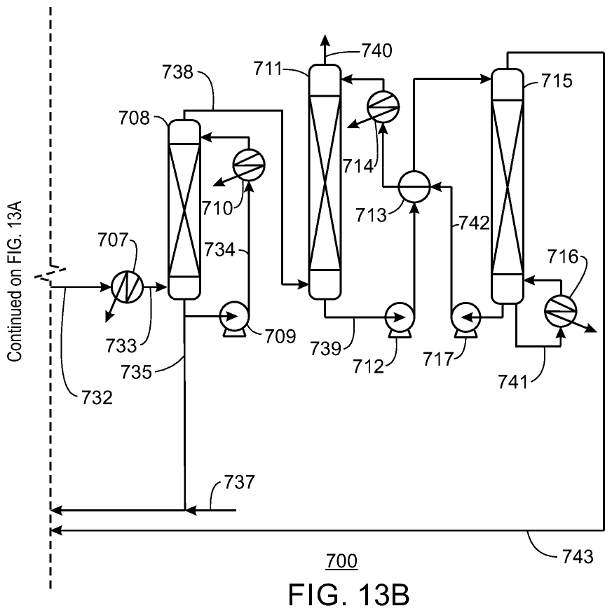

FIGS. 13A and 13B: Indirect heating of S and water (via indirect heating with electric heater or boiler) for sulfur steam reforming in a reductive environment of a sulfur steam reformer. There is no Claus furnace. There is no sulfur burner.

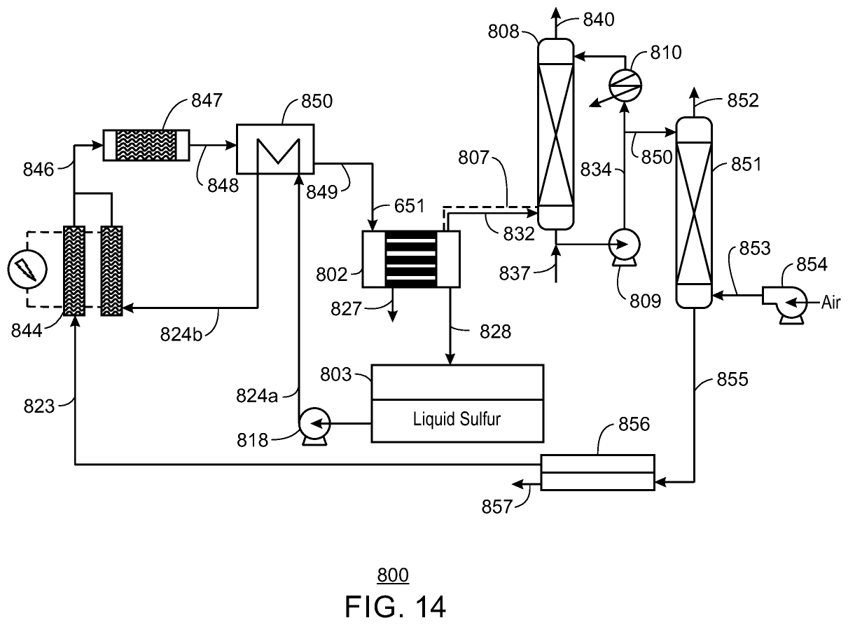

FIG. 14: Indirect heating of S and water (via indirect heating with electric heater or boiler) for sulfur steam reforming in an oxidative environment of a sulfur steam reformer. There is no Claus furnace. There is no sulfur burner.

In FIGS. 7A-8, S and water are externally injected into the Claus furnace 2^{nd} zone. In FIGS. 9-12, the system is not depicted as externally injecting S and water into the Claus furnace 2^{nd} zone. Nevertheless, a relatively small amount of sulfur steam reforming may occur in the furnace 2^{nd} zone without injection of S and H₂O because S and H₂O may be present. In FIGS. 13-14, there is no Claus furnace.

In FIGS. 7A, 9A, and 10A, the system includes Claus catalytic converters downstream of the Claus furnace.

In FIGS. 8, 11, and 12, the system as depicted does not include catalytic converters downstream of the Claus furnace. Therefore, the Claus furnace can be characterized as a Claus-type furnace not in a Claus system having catalytic stages.

In FIGS. 7B, 9B, 10B, and 13B, downstream in the system includes water quenching (to condense and remove water vapor) and selective amine treating to remove H₂S. In FIGS. 8, 11, 12, and 14, downstream in the system includes quenching with aqueous sulfurous acid to remove SO₂ and H₂S, and oxidation of excess aqueous sulfurous acid with oxygen gas in air to give sulfuric acid.

In FIGS. 13A and 14, liquid sulfur is fed to the system. There is no Claus furnace or Claus catalytic reactors. The system is not a Claus system.

FIGS. 7A and 7B are a hydrogen production system 100 that can be a sulfur recovery unit (SRU) (e.g., Claus system) modified for production of hydrogen. An SRU has a reaction furnace vessel (e.g., Claus furnace 101) that receives acid gas having H₂S to combust the H₂S in a 1^{st} zone of the furnace. For H₂ production, elemental S and water can be fed (including externally injected) to the 2^{nd} zone of the furnace to steam reform the S to generate hydrogen gas (H₂) that is recovered downstream as product.

The SRU converts the H₂S into elemental S and recovers elemental S. The SRU includes the reaction furnace (e.g., 101) and catalytic converters (e.g., 105) (catalytic reactor vessels) downstream of the reaction furnace that convert H₂S into elemental S. Condenser heat exchangers (e.g., 102a, 102b, 102c) may condense the elemental S gas/vapor into elemental S liquid for recovery (e.g., as molten sulfur to a sulfur pit). The condenser heat exchangers (e.g., shell-and-tube heat exchangers) may also generate steam by vaporizing the water cooling medium with heat from the elemental S gas/vapor.

The furnace that converts H₂S into elemental S may be in the thermal section of the Claus main portion of the system 100. The catalytic converters that convert H₂S into elemental S may be in the catalytic section of the Claus main portion of the system 100.

The system 100 includes the Claus furnace 101 vessel having a 1^{st} zone 101a and a 2^{nd} zone 101b. In implementations, an inlet part 101x of the furnace 101 mixes streams 121, 122, 143 (having combustible gases) in a nozzle and incorporates oxygen 120 (e.g., from air) to ignite the mixture into the furnace flame for combustion in the furnace combustion chamber. The combustion chamber of the furnace 101 includes the 1St zone 101a and the 2^{nd} zone 101b. The combustion chamber of the furnace 101 has an internal baffle separating the combustion chamber into the 1^{st} zone 101a (closest to the inlet part 101x) and the 2^{nd} zone 101b (closest to the boiler 101c). The 1^{st} zone 101a may operate at a temperature, for example, in the range of 1200° C. to 1600° C. The Claus furnace 101 includes (or is associated with) a heat exchanger 101c to cool the furnace gas and generate steam 125 by vaporizing the water cooling medium. The heat exchanger 101c can be part of the furnace 101 vessel. The heat exchanger 101c part can be labeled as a boiler or waste heat boiler (WHB) in implementations.

In operation, acid gas 121 is fed to the 1St zone 101a of the furnace 101, which may flow through the inlet part 101x and/or directly into the 1^{st} zone 101a. The acid gas 121 includes at least carbon dioxide (CO₂) and H₂S. The acid gas 121 may be labeled as sour acid gas because the acid gas includes H₂S as an acid gas. The acid gas 121 and recycled H₂S 143 may be partially burned with fed oxygen gas 120 in the 1^{st} zone 101a of the Claus furnace 101. The Claus furnace 101 (and associated condenser 102a) may be considered a thermal stage of the SRU. The oxygen 120 can be provided in fed air, or from an enriched or pure oxygen source. A fuel gas 122, such as methane, can be added to the furnace 101 to maintain the temperature of the furnace.

With the acid gas 121 fed for combustion in the 1^{st} zone 101a of the Claus furnace 101, an oxidation reaction in the thermal stage in the reaction furnace 101 (thermal reactor) is 2H₂S+3O₂→2SO₂+2H₂O, which is the oxidation of the entering H₂S from the fed acid gas 121 with fed oxygen (02) gas 120 to give SO₂ and water (H₂O) vapor. The reaction furnace 101 as a thermal reactor may also perform the Claus reaction 2H₂S+SO₂→3S+2H₂O in 101c, in which H₂S gas and SO₂ react to give elemental sulfur (S) gas and water vapor. An overall reaction for the SRU (e.g., Claus system) involving these two reactions (oxidation reaction and Claus reaction) may be characterized as 2H₂S+O₂→2S+2H₂O.

The Claus reaction 2H₂S+SO₂→3S+2H₂O may also be performed (as a catalytic reaction) in the catalytic converters 105 (catalytic reactors) that each have catalyst (a catalyst bed) for performing the Claus reaction. The catalyst is employed to convert (promote the conversion of) the H₂S and SO₂ to sulfur. The catalyst (e.g., Claus catalyst) may include activated alumina catalyst. The catalyst may include activated aluminum(III) oxide and/or titanium(IV) oxide. Other Claus catalysts are applicable.

With the acid gas 121 fed for combustion in the 1^{st} zone 101a of the Claus furnace 101, a mixture of water 123 and liquid sulfur 124 may be injected into the 2^{nd} zone 101b of the Claus furnace 101. The reaction of sulfur steam reforming in the 2^{nd} zone may occur at temperatures above 445° C. (718.15° K). In these implementations, the 2^{nd} zone 101b can be labeled as a sulfur steam reformer. The mixture (as injected) of water 123 and liquid sulfur 124 in the 2^{nd} zone 101b of the Claus furnace may be considered the “direct heating” of the water 123 and the sulfur 124. In other words, the injected mixture (123 and 124) is directly in contact with the hotter combustion gas from combustion of the acid gas 121. In other words, the furnace gas from the 1^{st} zone 101a, which includes hot combustion gas, heats by direct contact the water 123 and sulfur 124 in the 2^{nd} zone 101b.

The furnace gas from the 2^{nd} zone 101b of the Claus furnace may be cooled in the heat exchanger 101c part (e.g., as WHB) of the Claus furnace 101. Steam 125, e.g., high-pressure steam in the range of 600 pounds per square inch gauge (psig) to 900 psig may be generated (e.g., from boiler feedwater, demineralized water, steam condensate, etc.) on the side of the heat exchanger 101c (e.g., a shell-and-tube heat exchanger) opposite the furnace gas.

The furnace exhaust gas 126 (furnace exhaust gases discharged from the heat exchanger 101c as cooled gases) (e.g., having temperature of less than or equal to 315° C.) exiting from the heat exchanger 101c enters a condenser 102a heat exchanger (e.g., a shell-and-tube heat exchanger). The furnace exhaust gas 126 may be characterized as a process stream in having the H₂ produced in the furnace 101 to be recovered. The condenser 102a discharges low-pressure steam 127a, liquid sulfur 128a going to the sulfur receiver 103, and process gas 129a going to a reheater 104a. The sulfur receiver 103 may be labeled as a sulfur pit, which can include a sulfur receptacle, container, or vessel, and so on. The sulfur receiver or sulfur pit may be a storage vessel in which sulfur that has been condensed is received, and accumulated and stored. A sulfur pit may temporarily accommodate elemental S extracted from an SRU or similar system and that may be conveyed for further processing or to transportation systems, and the like.

The gas 129a may be labeled as a process stream in having the H₂ produced in the furnace 101 to be recovered, and in having H₂S and SO₂ to be converted into elemental S in the Claus reaction. The condenser 102a condenses (with water as cooling medium) the elemental S gas/vapor in the furnace exhaust gas 126 to give the liquid sulfur 128a. The heat removed from the furnace exhaust gas 126 vaporizes the water cooling medium to give the steam 127a (e.g., less than 150 psig). The furnace exhaust gas 126 not condensed discharges as process gas 129a to the reheater 104a heat exchanger. The process gas 129a includes H₂, CO₂, H₂S, H₂O, SO₂, and typically entrained residual S, and includes N₂ if air is fed for the oxygen gas 120 to the furnace 101.

Each Claus catalytic stage (of the H₂ production system 100 as an SRU or Claus system) may have a reheater (e.g., 104a), a Claus catalytic converter 105 (catalytic reactor vessel that is a vessel having a bed of catalyst, e.g., Claus catalyst), and a condenser (e.g., 102b). For clarity, only one Claus catalytic stage is depicted. The system 100 may include 2-4 such catalytic stages. Typical Claus systems may have 2-3 catalytic stages. While only one catalytic stage is depicted, additional Claus catalytic stages (e.g., one additional catalytic stage as the second catalytic state, or two additional catalytic stages as the second catalytic stage and third catalytic stage) are indicated by reference numeral 145.

The reheater 104a heat exchanger heats the process gas 129a to give reheated process gas 130a entering the catalytic converter 105 of that catalytic stage. The reheater may facilitate control of catalyst bed temperature in the catalytic converter 105. The reheater may be, for example, an indirect steam reheater (e.g., shell-and tube heat exchanger) in which the process stream (gas) is heated with steam as heating medium. The reheater may be, for example, a fired-reheater (e.g., direct-fired heater) (e.g., a burner) that burns fuel gas or acid gas to heat the process stream.

The reheated process gas 130a (a gas mixture) enters a first of a series of the catalytic converters 105 (each with an associated condenser 102b heat exchanger for that respective catalytic stage). Again, for clarity, only one catalytic converter 105 is depicted. Each catalytic converter 105 may perform the Claus reaction converting H₂S and SO₂ in the process gas to elemental S and H₂O. The associated condenser 102b heat exchanger may condense elemental S gas/vapor from the process gas that discharges from the catalytic converter 105 the into liquid elemental sulfur 128b that is recovered. The condenser 102b (e.g., shell-and-tube heat exchanger) may also generate steam 127b (e.g., low pressure steam at less than 150 psig) by vaporizing the water cooling medium. The process gas minus the remove condensed sulfur 128b may be forwarded through the next reheater 104a to the next catalytic converter 105 of the next catalytic stage.

The process gas flows through the series of converters 105. After the second or third catalytic converter 105 (not shown) with its respective condenser heat exchanger 102b (not shown), the gas mixture 129b (as the process gas) is heated in a reheater 104b to give the process gas 130b (as heated) as the process stream that goes through a hydrogenation reactor 106 vessel.

The hydrogenation reactor 106 may be part of a typical or conventional Claus system. The hydrogen gas in the process gas 130b may be utilized for the hydrogenation in the reactor 106. The reactor 106 may have catalyst to promote the hydrogenation. For example, the reactor 106 may have a catalyst bed of cobalt-nickel catalyst or cobalt-molybdenum catalyst. In implementations, the reactor 106 may be similar to the hydrogenation reactor in the Shell Claus off-gas treating (SCOT) process/system. Compounds hydrogenated in the reactor 106 may include SO₂ (e.g., traces of SO₂ in the process gas 130b) into H₂S. A purpose of the hydrogenation may be to assure that little or no SO₂ goes to the absorber 111 because the SO₂ could react with the amine in the absorber 111 to form stable salts, and therefore decreasing the performance of the absorber to capture H₂S. In other words, SO₂ could transform amine into an unreactive species towards H₂S.

The hydrogenated gas 131b (process gas having the H₂ product) discharged from the hydrogenation reactor 106 is cooled in the cooler 102c utilizing water as the cooling medium. The cooler 102c may be, for example, a shell-and-tube heat exchanger. The condenser 102c may generate low pressure steam (e.g., less than 150 psig) by vaporizing the water cooling medium with heat from the hydrogenated gas 131b. The cooler 102c discharges process gas 132 (gas mixture) that is the hydrogenated gas 131b lower in temperature as cooled by the cooler 102c. The process gas 132 may include H₂, CO₂, H₂O, N₂ (if air is fed for the oxygen gas 120), and residual H₂S (e.g., a relatively small amount of H₂S less than 3 or 4 volume percent [vol %]).

The process gas 132 may be further processed to recover H₂ from the process gas 132. In implementations, the process gas 132 may be labeled as Claus tail gas but having a significant amount of H₂ (generated via the S steam reforming in the furnace 101). As discussed below, the further processing of the process gas 132 may include removing water from the process gas 132 in a quench tower 108, and treatment in an amine system (including absorber 111 and regeneration column 115) to remove H₂S, to give the product H₂ along with CO₂ and any N₂.

The process gas 132 (gas mixture) discharged from the condenser 102c may be further cooled with heat exchanger 107 (e.g., a shell-and-tube heat exchanger) that generates steam (e.g., low-low pressure [LLP] steam less than 60 psig) from the water cooling medium in the heat exchanger 107.

The cooled process gas 133 (a gas mixture as the process stream) discharged from the condenser 102c may enter a quench tower 108 (e.g., a vertical vessel), where the gas is cooled (e.g., to 60° C. or less) by passing the gas in countercurrent flow with water 134 having a lower temperature than the gas. The quench tower 108 vessel may have, for example, packing in the vessel to provide for increased contact of the gas mixture 138 (flowing upward with the tower 108) with the water 134 (flowing downward through the tower 108). The water 134 can be labeled as quench water. The water vapor in the gas is condensed in the quench tower 108. This condensed water as excess water is removed from the quench tower 108 as water 135 discharged from a bottom part of the quench tower 108.

A portion of the water 135 is sent as water 137 to sour water treatment. Another portion of the water 135 is sent to the furnace 101. Yet another portion 134 of the water 135 is routed through an air cooler 110 heat exchanger via a pump 109 (e.g., a centrifugal pump) as recycle to an upper part of the tower 108. The water 134 may discharge from the air cooler 110, for example, at 60° C. or less.

The overhead gas 138 discharging overhead from the quench tower 108 is generally the process gas 133 entering the tower 108 minus the water vapor condensed and removed from the process gas 133. The overhead gas 133 may be sent to gas sweetening unit (an amine treating system) to separate the H₂S from the H₂ in the overhead gas 133. The amine treating system includes the absorber 111 and the regeneration distillation column 115 (also called a desorber), e.g., as described in U.S. Pat. No. 10,525,404 B2, U.S. Pat. No. 11,241,652 B2, and U.S. Pat. No. 11,130,094 B2, all three of which are incorporated herein by reference in their entirety.

The overhead gas 138 from the quench tower 108 may enter the absorber 111, such as of a selective amine treatment system, to separate H₂S from the H₂ gas. In particular, the overhead gas 138 from the quench tower 108 enters at a bottom portion of the absorber 111 column vessel (e.g., having packing) and flows upward in a countercurrent flow direction with respect to liquid aqueous amine flowing downward through the absorber 111. The amine absorbs H₂S from the gas 138 to give an intermediate product gas 140 discharged overhead from the absorber 111.

In implementations, the amine does not readily absorb CO₂, so that the CO₂ does not discharge with H₂S 143. Selective amine process may work on the principle that the chemical structure of selective amine, e.g., methyldiethanolamine (MDEA), is not suited to form a carbamate with CO₂, as the MDEA does not have a proton on the nitrogen, and can only sequester dissolved CO₂ (or carbonic acid) via deprotonation. Similarly, the amine will capture H₂S via deprotonation. However, the rate of gas dissolution in amine solution (H₂S being faster than CO₂) is large enough that, using the residence time and absorber temperature, the selective amine process can separate with high selectivity H₂S from CO₂. It is possible that there are traces of CO₂ in H₂S 143 stream. If so, the amount is very small.

The intermediate product gas 140 (a gas stream) has the H₂ product. The intermediate product gas 140 is labeled as intermediate because the gas 140 includes CO₂ in addition to the H₂. The intermediate product gas 140 includes H₂ and CO₂, and may further include N₂ gas if air is used as a source of oxygen gas 120. Again, the intermediate product gas 140 discharged overhead from the absorber 111 has H₂ gas as a product along with CO₂ (and N₂ gas if air is utilized as the oxygen 120 source). The intermediate product gas 140 may be further processed to isolate the product H₂ gas, for example, by membrane separation, pressure swing adsorption (PSA), etc.

The bottoms stream 139 including liquid amine having H₂S separated from the hydrogen gas discharges from a bottom portion of the absorber 111 vessel and is sent via the pump 112 through a heat exchanger 113 as feed to the regeneration distillation column 115 (also known as a desorber vessel). The bottom stream 139 is rich in H₂S. In the regeneration column 115, H₂S is removed (desorbed) from the amine. An H₂S-enriched gas 143 discharges overhead from the regeneration distillation column 115 and is recycled as feed to the furnace 101. A complementary gas in this H₂S-enriched gas 143 that is recycled to the furnace 101 may be carbon dioxide.

The regeneration (desorber) column 115 has an associated reboiler 116 heat exchanger (e.g., with steam as the heating medium). Bottoms liquid 141 from a bottom portion the regeneration column 115 is vaporized in the reboiler 116 (e.g., steam reboiler) for flow as vapor upward through the column 115.

Bottoms liquid 142 (liquid amine lean in H₂S) from the bottom portion of the regeneration distillation column 115 is sent via pump 117 through the heat exchanger 113 (e.g., shell and tube heat exchanger) and the heat exchanger 114 to an upper portion of the absorber column 111. Both heat exchangers 113, 114 cool the bottoms liquid 142.

The regeneration column 115 may be characterized as a regeneration column because the regeneration column 115 receives the bottoms stream 139 (relatively rich in H₂S) (labeled as rich amine because amine rich in H₂S) from the absorber column 111 and returns the stream 142 lean in H₂S (labeled as lean amine because amine lean in H₂S) to the absorber column 111. Again, the intermediate product gas 140 discharged from the absorber 111 (e.g., discharged overhead from the absorber 111) includes H₂ (as product) and may include CO₂, and may further include N₂ if air is used as a source for feed O₂ 120.

As mentioned, the first application category of direct heating of the water vapor and sulfur vapor may be performed in the oxidative environment, as indicated in the example of FIG. 8. An excess of SO₂ exists in the furnace. The excess of SO₂ may be due to the sulfur steam reforming reaction in the furnace. Catalytic converters are not employed because there is little or no H₂S, or sub-stoichiometric H₂S with respect to SO₂, in the furnace discharge gas.

FIG. 8 is a hydrogen production system 200 employing a Claus-type furnace 201. Sour acid gas 221 and recycled sulfuric acid 259 are partially burned with oxygen 220 (e.g., from fed air) in the 1^{st} zone 201a of the Claus furnace 201. The oxygen gas 220 fed for the 1^{st} zone 201a can come from air that is fed or from an enriched/pure oxygen source. The Claus furnace 201 operating temperature in the 1^{st} zone 101a may be, for example, in the range of 1200° C. to 1600° C. A fuel gas 222, such as natural gas or methane, can be added to give combustion to maintain the temperature of the furnace 201. The fed acid gas 221 can be replaced by liquid elemental S (in that liquid S is fed instead of acid gas 221). In that case, the combustion may be labeled as occurring in a sulfur burner instead of a Claus furnace. The liquid sulfur (if fed in lieu of acid gas 221) may be fed to both the 1^{st} zone and the 2^{nd} zone? The liquid sulfur fed to the 1^{st} zone may facilitate to bring the reaction to temperature (via combustion of S) the liquid sulfur fed to the 2^{nd} zone may be for the performance of the sulfur steam reforming reaction.

For the acid gas 221 as feed, a mixture of water 223 and liquid sulfur 224 is injected into the 2^{nd} zone 201b of the Claus furnace 201. This may be characterized as direct heating of the water 223 and the liquid sulfur 224. The reaction of the sulfur steam reforming (the steam reforming of the sulfur) in the 2^{nd} zone 201b occurs at a temperature above 445° C. (718.15° K). The sulfur steam reforming (reaction of elemental S with H₂O) generates H₂ that is recovered downstream as product, and therefore the system 200 may be labeled as an H₂ production system.

The furnace gas (having the H₂) from the 2^{nd} zone of the Claus furnace is cooled in the heat exchanger part 201c of the Claus furnace 201. This cooling in the heat exchanger 201c (e.g., WHB) of the furnace 201 produces steam 225 on the other side of the heat exchanger 201c. In other words, the furnace gases are cooled on one side of the heat exchanger 201c (e.g., shell-and-tube heat exchanger), and the water cooling medium is vaporized into steam on the other side of the heat exchanger 201c that discharges as steam 225 (e.g., high pressure steam in the range of 600 psig to 1500 psig).

The furnace exhaust gas 226 is the furnace exhaust gases discharged from the heat exchanger 201c. The furnace exhaust gas 226 as exiting gases from the furnace 201 (discharged from furnace part 201c) may have a temperature, for example, of less than or equal to 315° C. The temperature (e.g., 300° C. to 315° C.) may be significant as it may correspond to a minimum of molten sulfur viscosity. The furnace exhaust gas 226 enters a condenser 202 (e.g., shell-and-tube heat exchanger) that produces low-pressure steam 227 (e.g., <150 psig), liquid sulfur 228 going to the sulfur pit 203, and process gas 232 (cooler gases) maintained at temperature as discharged with heat tracing 207 to avoid sulfur deposition. The process gas 232 discharged from the condenser 202 may be labeled as a process stream because the process gas 232 includes H₂ (generated in the sulfur steam reforming in the 2^{nd} zone 201b of the furnace 201) to be recovered as product.

The cooling medium for the condenser 202 may be water (e.g., boiler feedwater, demineralized water, steam condensate, etc.) that is vaporized on one side of the condenser 202 heat exchanger with heat from the furnace exhaust gas 226 on the other side of the condenser 202 heat exchanger to give the steam 227. The condenser 202 condenses (with the water cooling medium) the elemental S vapor in the furnace exhaust gas 226 to give the liquid elemental sulfur 228 discharged to the sulfur pit 203. The furnace exhaust gas 226 minus the condensed elemental sulfur 228 discharges as process gas 232 (e.g., cooler gases in having a lower temperature than the furnace exhaust gas 226) to the quench tower 208. The process gas 232 includes H₂ (generated in the sulfur steam reforming in the 2^{nd} zone 201b), H₂S, SO₂, CO₂, and relatively small amount of S vapor. The heat tracing 207 may be disposed along the conduit conveying the process gas 232 to the quench tower 208 to prevent or reduce sulfur deposition (from elemental S vapor) in the process gas 232. The heat tracing 207 may be, for example, electrical tracing or steam tracing, as would be appreciated by one of ordinary skill in the art. The heat tracing 207 may be a component of a heat tracing system.

The process gas 232 enters the quench tower 208, where the gas mixture is cooled (e.g., to 60° C.) by passing the gas in countercurrent flow with aqueous sulfurous acid 234. The residual elemental S entrained in the gas stream 232 is transformed into soluble polythionic acid in presence of excess of sulfurous acid. Therefore, no (or little) solid—or slurry—is accumulated in the quench tower 208. The quench tower 208 may remove SO₂ by absorption of SO₂ into the aqueous sulfurous acid 234. The dissolved SO₂ may hydrate into sulfurous acid SO₂+H₂O=>H₂SO₃. The H₂S may react readily with sulfurous acid to form sulfur colloid and subsequently polythionic acid. The gas 240 (gas stream) that discharges overhead from the quench tower 208 includes the product H₂ gas, along with CO₂ if liquid sulfur is not fed in lieu of acid gas 221 to the furnace 201. The gas 240 may additionally include N₂ gas if air is the oxygen 220 source. The gas 240 can be utilized as product or can be processed to isolate the H₂ gas as product.

A makeup of the water (makeup water 237) may be added to the bottoms stream 209 of water (aqueous sulfurous acid) that discharges from the bottom portion of the tower 208 to give water 234. The water 234 (aqueous sulfurous acid) is sent via a pump 209 through an air cooler 210 heat exchanger to an upper part of the tower 208. The acid(s) in the water 234 may be sulfurous acid and some traces of polythionic acid. The water 234 may more accurately be labeled as aqueous sulfurous acid or aqueous sulfurous acid solution. The air cooler 210 may cool (with air as cooling medium) the water 234, for example, to a temperature less than 60° C.

A portion 250 of the water 234 (aqueous sulfurous acid) (e.g., upstream of the cooler 210) is sent to an oxidation tower 251 vessel. The portion 250 of the water 234 may enter at an upper part of the oxidation tower 251 and flow downward in the tower 251 in a countercurrent flow direction with respect to the air 253 flowing upward through the tower 251. The air 253 may be injected into a bottom part of the tower 251 via a blower 254 (e.g., centrifugal fan) (e.g., that receives ambient air or plant utility air). The oxygen gas in the air 253 may oxidize the aqueous sulfurous acid (H₂SO₃) into sulfuric acid (H₂SO₄) in the oxidation tower 251. The overhead gas 252 (e.g., air substantially depleted in oxygen) exiting overhead from the oxidation column 251 includes the air 253 minus the O₂ gas from the air 253 utilized in the oxidation. Thus, the overhead gas 252 is N₂ gas with some O₂ gas (e.g., 2-4 vol % of O₂).

Aqueous sulfuric acid 255 discharges (e.g., as a bottoms stream) from a bottom portion of the tower 251 and is sent through a membrane 256. The membrane 256 may be a nanofiltration (NF) membrane, reverse osmosis (RO) membrane, etc., and associated membrane system. The membrane treatment of acidic aqueous waste is well known in the mining industry. Polymeric membranes are applicable for the recovery of sulfuric acid. An example of applicable polymer membrane is TFC-HR (thin film composite polyamide membrane) of Koch Membrane Systems available from Koch Industries, Inc. having headquarters in Wichita, Kansas USA. Another example of an applicable polymer membrane is HYDRACoRe70pHT (sulfonated polyethersulfone membrane) from Hydranautics of Nitto Denko Corporation having headquarters in Osaka, Japan. Yet another example is Desal KH (piperazine-based polyamide membrane) available from Suez Waters USA Inc. having headquarters in Revose, Pennsylvania USA.

The membrane 256 discharges sulfuric acid 257 (e.g., more concentrated than the entering sulfuric acid 255) as retentate, and relatively pure or clean water 223 as permeate. A portion 258 of the sulfuric acid 257 (e.g., concentrated) is removed as product to be valorized. Another portion 259 of the concentrated sulfuric acid 257 is provided (e.g., conveyed via a conduit) to the furnace 201 to enrich the Claus furnace 201 in oxygen, in which aspects may be described in the U.S. Pat. No. 4,826,670, US Published Patent Application No. 2022/0177306A1, and US Published Patent Application No. 2022/0199908A1, all three of which are incorporated by reference herein in their entirety.

In embodiments, for the aforementioned indirect heating, the elemental S vapor and water for the sulfur steam reforming may be heated, for example, via [1] a sulfur burner or via [2] an electric heater or boiler. This heating of the S vapor and water may be labeled as indirect heating for the sulfur steam reformer. For instance, such may be characterized as indirect heating in that the S vapor and water is not directly heated in the Claus furnace 2^{nd} section labeled as a sulfur steam reformer. Such may also be characterized as indirect heating because the heating in the sulfur, electric heater, or boiler may be indirect (not direct contact with the heating medium). For instance, the heating in sulfur burner may be characterized as indirect because the heat transfer is by conduction through the tube wall.

The S vapor with water as heated via the sulfur burner or electric heater (or boiler) may be subjected to steam reforming in a sulfur steam-reformer vessel to generate H₂. The reformed mixture having H₂ discharged from the sulfur steam reformer may be combined with the furnace exhaust gas discharged from the Claus furnace (if present). Furthermore, as indicated, the indirect heating may be implemented associated with the reductive environment in the Claus furnace 2^{nd} zone or with the oxidative environment in the Claus furnace 2^{nd} zone, or in the sulfur steam reformer if a Claus furnace is not utilized in the system.

Described below for indirect heating for sulfur steam reforming in a sulfur steam reformer separate from the Claus furnace or Claus-type furnace include: [a] a system (e.g., FIGS. 9A and 9B) having a reductive environment in the furnace 2^{nd} zone and indirect heating via a sulfur burner (flame heater) for the sulfur steam reformer separate from Claus furnace; [b] a system (e.g., FIGS. 10A and 10B) having a reductive environment in the furnace 2^{nd} zone and indirect heating via an electric heater or boiler for the separate sulfur steam reformer; [c] a system (e.g., FIG. 11) having an oxidative environment in the furnace 2^{nd} zone and indirect heating via a sulfur burner (or flame heater) for the separate sulfur steam reformer; and [d] a system (e.g., FIG. 12) having an oxidative environment in the furnace 2^{nd} zone and indirect heating via an electric heater or boiler for the separate sulfur steam reformer. The heating in the sulfur burner may be considered “indirect” heating because sulfur and water are not in direct contact with the combustion gases, but instead heat is transferred by conduction through the tube wall.

The term “indirect” heating may mean that the heat transfer in the sulfur burner, electric heater, and boiler is not by direct contact with the heating medium but instead by indirect contact. In implementations, if a heating element of the electric heater is immersed in the fluid being heated, that is generally not considered direct heating in the present context.

FIGS. 9A and 9B are a hydrogen production system 300 that can be a sulfur recovery unit (SRU) (e.g., Claus system) incorporating production of hydrogen. An SRU has a reaction furnace (e.g., Claus furnace 301) that receives acid gas (e.g., 321) having H₂S to combust the H₂S in a 1^{st} zone of the furnace. For hydrogen production, elemental sulfur and water are heated in a sulfur burner 344 and the sulfur is steam reformed in a sulfur steam reformer 347 (that receives the heated mixture of sulfur and water) to generate H₂ gas for recovery downstream. In implementations, the sulfur burner 344 and sulfur steam reformer 347 may be characterized as operationally in parallel with the Claus furnace 301.

The SRU converts the H₂S into elemental sulfur and recovers elemental sulfur. The SRU includes the Claus reaction furnace 301 that converts H₂S into elemental S gas (vapor), and catalytic converters 305 (catalytic reactor vessels) downstream of the reaction furnace 301 that convert H₂S into elemental S gas (vapor). Condenser heat exchangers (e.g., 302a, 302b, 302c) may condense the generated elemental S gas into elemental S liquid (e.g., 328a, 328b) for recovery (e.g., as molten sulfur to a sulfur pit 303).

In FIG. 9A, a sulfur burner 344 has a combustion chamber for combusting sulfur and a tube side to receive the combustion gases to heat gas components on the shell side. In operation, the sulfur burner 344 is fed liquid water 323, liquid elemental sulfur 324c, and H₂S gas 343 to the shell side of the burner 344. The sulfur burner 344 heats the liquid water 323, the liquid elemental sulfur 324c, and the H₂S gas 343 on the shell side (outside of the heat exchanger tubes) to a temperature of at least 445° C. (718.15° K).

The sulfur burner 344 discharges from the shell side a mixture 346 (as heated to at least 445° C.) of H₂O vapor, H₂S and S vapor to the sulfur steam reformer 347. IN implementations, the sulfur steam reformer 347 may be, for example, a relatively large pipe with a static mixer in the pipe to increase gas-gas contact. The internal in the steam reformer 347 may be the static mixer. Thus, the sulfur steam, reformer can be consider a wide spot in the line with an in-line static mixer.

In implementations, heat is not added to the reformer 347, other than the heat in the entering mixture 346. In other implementations, a heating element can be included on the exterior of reformer. However, the temperature of stream 346 (e.g., about 600° C.) may be considered adequate and without significant effect of heat losses from the pipe. The sulfur steam reforming in the sulfur steam reformer 347 involves reacting the S vapor with H₂O to generate H₂. The H₂S present may convert the SO₂ produced by the S steam reforming into liquid sulfur during the cooling stage. As for heat management, the stream 343 may generally not need to be heated and could be added to the stream 348.

The sulfur steam reformer 347 discharges a reformed mixture 348 (products of the sulfur steam reformer 347 including H₂) to an economizer 350. The economizer 350 cools the reformed mixture 348 to discharge the cooled reformed mixture 349 having the H₂. The economizer 350 may be a shell-and-tube heat exchanger. An economizer may be a heat exchanger in which the respective hot and cold sources (streams) that are cross-exchanged are from the system/process (process streams). In other words, an economizer may recover heat from the system (process).

The economizer 350 recovers heat from the reformed mixture 348 and transfers the heat to the liquid sulfur 324a to heat (pre-heat) the sulfur 324a to increase the temperature of the liquid sulfur 324a. The liquid sulfur 324a as heated in the economizer 350 is fed as [1] heated liquid sulfur 324b for combustion in the sulfur burner 344 and as [2] heated liquid sulfur 324c on the shell side (outside the tubes) of the sulfur burner 344.

The heat in the sulfur burner 344 is provided via combustion (e.g., total combustion) of the liquid sulfur 324b with oxygen 320b in the combustion chamber and inside heat exchanger tubes (e.g., on the tube side) of the sulfur burner 344. In implementations, air can be fed to provide the oxygen 320b. The products of the combustion on the tube side in the sulfur burner 344 include SO₂ (and N₂ gas if air is the oxygen 320b source) and a slight excess of O₂ gas (e.g., <2 vol %). These combustion gases 345 may be routed (e.g., via a conduit) as discharged from the tube side of the sulfur burner 344 to the 1^{st} zone 301a of the Claus furnace 301.

In the Claus furnace 301, the sour acid gas 321 (having H₂S as an acid gas) is burned (e.g., partially burned) with oxygen 320a (e.g., from fed air) and with oxygen gas of the combustion gases 345 in the 1^{st} zone 301a of the Claus furnace 301. A fuel gas 322, such as methane, can be added to the 1^{st} zone 301a to maintain the temperature of the furnace 301. The gases in the furnace 301 react in the 2^{nd} zone 301b of the Claus furnace 301 (a reaction furnace). As is typical in a Claus reaction furnace, reactions may include oxidation reactions (e.g., 2H₂S+3O₂→2SO₂+2H₂O) and the Claus reaction in which the Claus reaction furnace 301 converts H₂S into elemental S (e.g., in the boiler 301c).

The furnace 301 gases are cooled (via water as cooling medium) in the heat exchanger part 301c of the Claus furnace 301. The heat exchanger part 301c may be labeled as a boiler or waste heat boiler (WHB) of (or associated with) the Claus furnace 301. The heat exchanger part 301c may generate (produce) steam 325 (e.g., high-pressure steam in range of 600 psig to 1500 psig) from the water cooling medium on the side of the heat exchanger 301c opposite the furnace gases.

The furnace exhaust gas 326 (exiting gases discharged from the furnace 301) and the cooled reformed mixture 349 having H₂ are routed (e.g., as combined into a gas stream 351) to the condenser 302a (e.g., shell-and-tube heat exchanger). The condenser 302a generates (produces) steam 327a (e.g., low pressure steam <150 psig) by vaporizing the water cooling medium with heat from the stream 351. In the condenser 302a, elemental S vapor in the gas stream 351 is condensed (via the water cooling medium) and discharges as liquid sulfur 328a, for example, to a sulfur pit 303. The entering gas stream 351 minus the condensed liquid sulfur 328 discharges from the condenser 302a as process gas 329a (cooler gases). The process gas 329a is labeled as process gas in having H₂ to be recovered.

The process gas 329a is sent through (and heated in) the reheater 304a heat exchanger, and discharges from the reheater 304a as reheated process gas 330a. The reheated process gas 330a is routed through a series of catalytic converters 305 (each having an associated condenser 302b). After the second or third catalytic converter 302 (not shown as indicated by reference numeral 345) with its respective condenser 302 (not shown as noted by reference numeral 345), the gas 329b (process stream having H₂) goes through a reheater 304b heat exchanger to be heated to give process gas 330b (as heated) routed to a hydrogenation reactor 306. The hydrogenation reactor 306 may be analogous to the hydrogenation reactor 106 of FIGS. 7A AND 7B. Only a relatively small fraction of the H₂ in the heated gas 330b is utilized in the hydrogenation (e.g., of SO₂ to H₂S) in the reactor 306.

The hydrogenated gas 331b (having H₂) discharged from the hydrogenation reactor 306 is cooled in the cooler 302c heat exchanger, which generates steam 327c (e.g., low pressure steam <150 psig). The cooler 302c discharges the cooled hydrogenated gas 331b as process gas 332 (gas mixture) that is the hydrogenated gas 331b lower in temperature as cooled by the cooler 302c. The process gas 332 may include H₂, CO₂, H₂O, N₂ (if air is fed for the oxygen gas 320a or 320b), and residual H₂S (e.g., a relatively small amount of H₂S less than 3 or 4 vol %).

The process gas 332 may be further processed to recover H₂ from the process gas 332. In implementations, the process gas 332 may be labeled as Claus tail gas but having a significant amount of H₂ (generated via the S steam reforming in the sulfur steam reformer 347). As discussed below, the further processing of the process gas 332 may include removing water from the process gas 332 in a quench tower 308, and treatment in an amine system (including absorber 311 and regeneration column 315) to remove H₂S, to give the product H₂ along with CO₂ and any N₂.

The process gas 332 (gas mixture) discharged from the condenser 302c may be further cooled with heat exchanger 307 (e.g., a shell-and-tube heat exchanger) that generates steam (e.g., low-low pressure [LLP] steam less than 60 psig) from the water cooling medium in the heat exchanger 307.

As discussed with respect to FIGS. 7A and 7B, the cooled process gas 333 (a gas mixture as the process stream) discharged from the condenser 302c may enter the quench tower 308 (e.g., a vertical vessel), where the gas is cooled (e.g., to 60° C. or less) by passing the gas in countercurrent flow with water 334 having a lower temperature than the gas. The quench tower 308 vessel may have, for example, packing in the vessel to provide for increased contact of the gas mixture (flowing upward with the tower 308) with the water 334 (flowing downward through the tower 308). The water vapor in the gas is condensed in the quench tower 108. Liquid water 335 including this condensed water discharges (e.g., as a bottoms stream) from a bottom part of the tower 308. The discharged water 335 may be split into three water streams 334, 337, and 323. The water 337 may be sent to sour water treatment. The water 323 may be sent to the shell side of the sulfur burner 344 (a furnace with heat exchanger tubes, as discussed). The water 334 may be recycled via a pump 309 through a cooler 310 heat exchanger to an upper part of the tower 308. The cooler 310 may reduce the temperature of the water 334 to less than 60° C. The cooling medium in the cooler 310 may be cooling water or air.

The overhead gas 338 discharged from a top portion of the quench tower 308 includes H₂, H₂S, and CO₂. The overhead gas 338 is sent to a gas sweetening unit (a selective amine process) that includes the absorber column 311 vessel that absorbs H₂S into liquid amine and the regeneration distillation column 315 vessel that removes H₂S from the liquid amine, and associated equipment. Examples of such systems to separate H₂S from the overhead gas 338, which is a mixture of H₂, H₂S, and CO₂ (and N₂ if air is used as a source of oxygen 320a to the furnace 301 or of oxygen 320b to the sulfur burner 347), are described in U.S. Pat. No. 10,525,404 B2, U.S. Pat. No. 11,241,652 B2, and U.S. Pat. No. 11,130,094 B2.

As discussed with respect to FIG. 7B, the overhead gas 338 from the quench tower 308 may enter the absorber 311, such as of a selective amine treatment system to separate H₂S from the H₂ gas. In particular, the overhead gas 338 from the quench tower 308 enters at a bottom portion the absorber 311 column vessel (e.g., having packing) and flows upward in a countercurrent flow direction with respect to liquid aqueous amine flowing downward through the absorber 311. The amine absorbs H₂S from the gas 338 to give an intermediate product gas 340 discharged overhead from the absorber 311. The intermediate product gas 340 has the H₂ product. The intermediate product gas 340 is labeled as intermediate because the gas 340 includes CO₂ in addition to the H₂. The intermediate product gas 340 includes H₂ and CO₂, and may further include N₂ gas if air is used as a source of oxygen gas 320a. Again, the intermediate product gas 340 discharged overhead as a gas stream from the absorber 311 has H₂ gas as a product along with CO₂ (and N₂ gas if air is utilized as the source of the oxygen 320a or 320b).

The absorber 311 and the regeneration distillation column 315, and associated equipment, may be considered an amine treatment system (a selective amine process).

The bottoms stream 339 including liquid amine having H₂S separated from the H₂ gas discharges from a bottom portion of the absorber 311 vessel and is sent via the pump 312 through a heat exchanger 313 as feed to the regeneration distillation column 315 (also known as a desorber vessel). The bottom stream 339 is rich in H₂S. In the regeneration column 315, H₂S is removed (desorbed) from the amine. A gas 343 enriched in H₂S (e.g., at least 50 vol % H₂S) discharges overhead from the regeneration distillation column 315. This gas 343 may be introduced to the shell side of the sulfur burner 344. This gas 343 sent to the sulfur burner 344 may include carbon dioxide.

The regeneration (desorber) column 315 has an associated reboiler 316 heat exchanger (e.g., with steam as the heating medium). Bottoms liquid 341 from a bottom portion the regeneration column 315 is vaporized in the reboiler 316 (e.g., steam reboiler) for flow as vapor upward through the column 315.

Bottoms liquid 342 (liquid amine lean in H₂S) from the bottom portion of the regeneration distillation column 315 is sent via pump 317 through the heat exchanger 313 (e.g., shell and tube heat exchanger) and the heat exchanger 314 (e.g., shell and tube heat exchanger) to an upper portion of the absorber column 311. Both heat exchangers 313, 314 cool the bottoms liquid 342. The heat exchanger 313 may be a cross-exchanger in which the bottoms liquid 342 is cooled by the bottoms stream 339 from the absorber 311, and in which the bottom stream 339 is heated by the bottoms liquid 342 from the regeneration column 315.

The regeneration column 315 may be characterized as a regeneration column because the regeneration column 315 receives the bottoms stream 339 (relatively rich in H₂S) (labeled as rich amine because amine rich in H₂S) as feed from the absorber column 311 and returns the stream 342 lean in H₂S (labeled as lean amine because amine lean in H₂S) to the absorber column 311. Again, the intermediate product gas 340 discharged from the absorber 311 (e.g., discharged overhead from the absorber 311) includes H₂ (as product) and may include CO₂, and may further include N₂ if air is used as a source for feed O₂ 320a or 320b.

FIGS. 10A and 10B are a hydrogen production system 400 that can be an SRU (e.g., Claus system) incorporating production of hydrogen, and is similar to the hydrogen production system 300 of FIG. 9A, except that an electric heater 444 or boiler is employed instead of a sulfur burner (e.g., 344 in FIG. 9A) to heat the S vapor and H₂O fed to the steam reformer 447 (e.g., 347 in FIG. 9A). The boiler, if employed, may be, for example, a steam heat exchanger. The boiler (if employed) here may have a flame that heats the water and transform the water into steam, which is further heated to give super-heated steam. This steam may be the calorie carrier, which will heat the mixture of S, H₂O, and H₂S. This boiler may be a steam superheater or superheated steam boiler.

Liquid water 423, liquid sulfur 424b, and hydrogen sulfide gas 443 are heated by the electric heater 444 (or boiler). In implementations, the electric heater may have electrical heating elements inside a vessel. The mixture is heated by heating elements, for instance, in a baffled U-shaped vessel. After being heated to a temperature above 445° C. (e.g., to at least 500° C., or in the range of 450° C. to 550° C.), the mixture 446 of water vapor, hydrogen sulfide, and sulfur vapor that discharges from the electric heater 444 is sent to a sulfur steam reformer 447. In the steam reforming of sulfur in the sulfur steam reformer 447, sulfur vapor reacts with H₂O vapor to generate H₂ gas that may be recovered downstream in the system 400. The reformed mixture 448 (products of the sulfur steam reformer 447) is sent to an economizer 450. The temperature of the reformed mixture 448 as discharged from the reformer 447 may be, for example, at least 600° C., or in the range of 550° C. to 650° C. The economizer 450 cools the reformed mixture 448 and recovers heat from the reformed mixture 448, and transfers the heat to the liquid sulfur 424a to increase the sulfur 424a temperature (e.g., to at least 300° C., such as in the range of 300° C. to 315° C.). The temperature of the cooled reformed mixture 449 that discharges from the economizer 450 may be, for example, less than 300° C.

In the Claus furnace 401 (a reaction furnace), the sour acid gas 421 (including H₂S and CO₂) is partially burned (combusted) with oxygen 420 (e.g., from fed air) in the 1^{st} zone 401a of the Claus furnace 401. The oxygen gas 420 can come from fed air or from an enriched or pure oxygen source. Fuel gas 422, such as methane or natural gas, can be added to facilitate maintaining the temperature of the furnace 401 at a desired temperature. An oxidation reaction in the furnace 401 an include, for example, 2H₂S+3O₂→2SO₂+2H₂O, which is the oxidation of the entering H₂S from the fed acid gas 421 with fed oxygen (02) gas 420 to give SO₂ and H₂O vapor. Furnace gases react in the 2^{nd} zone 401b of the Claus furnace 401. The reactions may include the Claus reaction 2H₂S+SO₂→3S+2H₂O, in which H₂S gas and SO₂ react to give elemental S gas and H₂O vapor. An overall reaction involving the oxidation reaction and the Claus reaction may be characterized as 2H₂S+O₂→2S+2H₂O.

The furnace gases from the 2^{nd} zone 401b are cooled in the heat exchanger part 401c of the Claus furnace 401. The heat exchanger part 401c utilizes water as a cooling medium. High-pressure steam 425 (e.g., in the range of 600 psig to 900 psig) may be generated by vaporizing the water cooling medium on the side of the heat exchanger part 401c opposite the furnace gases with heat from the furnace gases.

The furnace exhaust gas 426 (exiting furnace gases, e.g., having temperature less than 315° C., discharged from the heat exchanger part 401c) and the cooled reformed mixture 449 (having H₂) from the economizer 450 may be collected together as gas 451. The gas 451 enters a condenser 402a heat exchanger (with water as cooling medium) that produces steam 427a (e.g., low pressure steam less than 150 psig), liquid sulfur 428a sent to the sulfur pit 403, and process gas 429a (cooler gases) (having H₂) sent to a reheater 404a. The process gas 429a is labeled as process gas in having H₂ to be recovered. In addition to H₂, the process gas 429a may have H₂S, SO₂, CO₂, and uncondensed or entrained S, and N₂ (if air is fed for the O₂ gas 420). The process gas 429a is sent through (and heated in) the reheater 404a heat exchanger, and discharges from the reheater 404a as reheated process gas 430a.

The reheated process gas 430a is sent to a first catalytic converter of a series of catalytic converters 405 (each having an associated condenser 402b). The series of catalytic converters 405 is indicated by reference numeral 445. For instance, there may be a total of two or three catalytic converters 405, and a total of two or three condensers 402b. After the second or third catalytic converter 405 (not shown) with its respective condenser 402b (not shown), as noted by reference numeral 445, the gas 429b (process stream having H₂) from the final condenser 402b (not shown) goes through a reheater 404b heat exchanger to be heated to give process gas 430b (as heated) routed to a hydrogenation reactor 406.

The hydrogenation reactor 406 may be analogous to the hydrogenation reactor 106 of FIG. 7A and the hydrogenation reactor 306 of FIG. 9A. A relatively small amount of the H₂ in the heated gas 430b is utilized in the hydrogenation (e.g., to hydrogenate SO₂ into H₂S) in the reactor 406.

The hydrogenated gas 431b (having H₂) discharged from the reactor 406 is cooled in the cooler 402c heat exchanger, which generates low pressure steam 427c (e.g., less than 150 psig) by vaporizing the liquid water utilized as the cooling medium. The exiting gas mixture from the cooler is 402c is process gas 432 and is further cooled in the heat exchanger 407 to give cooled process gas 433 (a cooler gas than the process gas 432) and generate low-low pressure steam (e.g., less than 60 psig). The cooled process gas 433 includes H₂ and may include CO₂, H₂O, N₂ (if air is fed for the oxygen gas 420), and H₂S (e.g., at less than 3 or 4 vol %).

The cooled process gas 433 enters a quench tower 408, where the gas is cooled to 60° C. by passing the gas in countercurrent flow with cooler water 434. Water vapor in the cooled process gas 433 is condensed in the quench tower 408. Liquid water 435 including this condensed water discharges (e.g., as a bottoms stream) from a bottom part of the tower 408. A portion of the water 435 is sent as water 437 for disposal or for further processing, such as to sour water treatment. Another portion of the water 435 may be sent as water 423 through the electric heater 444 (or boiler) to the sulfur steam reformer 447. Yet another portion 434 of the water 435 is routed via the pump 409 (e.g., a centrifugal pump) through an air cooler 410 heat exchanger as recycle to an upper part of the tower 408. The water 434 may discharge from the air cooler 410, for example, at less than 60° C. As indicated, the water 434 may flow downward through the tower 408 in a countercurrent flow direction with the respect to the cooled process gas 438 flowing upward through the quench tower 408. The water 434 can be considered a quench medium, and that condenses or absorbs water from the cooled process gas 433.

The overhead gas 438 discharging overhead from the quench tower 408 is generally the cooled process gas 433 entering the tower 408 minus the water vapor condensed and removed from the process gas 433. The overhead gas 438 discharged from a top portion of the quench tower 408 includes H₂, H₂S, and CO₂ (and N₂ if air is the source of oxygen 420 fed to the furnace 401).

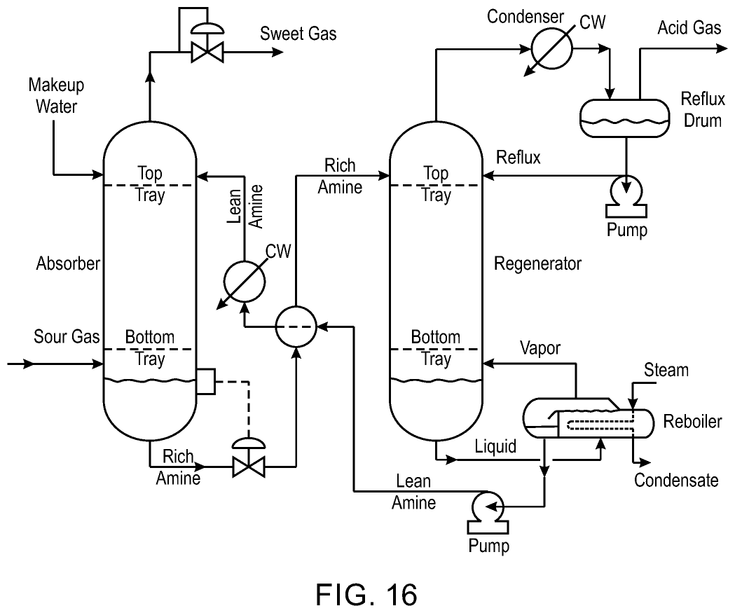

The overhead gas 433 may be sent to a gas sweetening unit (an amine treating system) to separate the H₂S from the H₂ in the overhead gas 433, as generally discussed with respect to the amine treatment system of FIGS. 7B and 9B. The amine treating system includes the absorber 411 and the regeneration distillation column 415 (also called a desorber). In implementations, an applicable example amine treatment system (a selective amine process) that may be analogous in depicted in FIG. 16.

A gas 443 enriched in H₂S (e.g., at least 50 vol % H₂S) discharges overhead from the regeneration distillation column 415. This gas 443 may include CO₂ and may be conveyed (e.g., via conduits) through the electric heater 444 (or boiler) to the sulfur steam reformer 447. Intermediate product gas 440 stream having H₂ product and CO₂ (and N₂ gas if air is used as a source of oxygen gas 420) discharges overhead from the absorber 411 column vessel. The intermediate product gas 440 may be utilized by a user (e.g., in a chemical process), or may be further processed to isolate the H₂ product. Hydrogen gas may be extracted and purified from this gas 440 (a mixture of H₂ and at least CO₂) that discharges overhead from the absorber 411.

The amine treating system (a selective amine process) includes pumps 412, 417 and heat exchangers 413, 414, 416, as discussed with respect to FIGS. 7B and 9B.

FIG. 11 is a hydrogen production system 500 that is similar to the system 300 of FIGS. 9A and 9B in the sense of employing indirect heating via a sulfur burner 544 to heat S and H₂O upstream of the sulfur steam reformer 547. Indirect heating for the sulfur steam reformer 547 is performed by heating the S gas and H₂O vapor in the upstream sulfur burner 544. The system 500 incorporates indirect heating of S and water (via heating with the sulfur burner 544) for sulfur steam reforming in the sulfur steam reformer 547 separate from the Claus furnace 501.

However, unlike system 300 of FIGS. 9A and 9B, the system 500 has an oxidative environment in the furnace 2^{nd} zone 501b and therefore no Claus catalytic converters (Claus catalytic reactors). The Claus furnace 2^{nd} zone 501b has an oxidative environment and performs the Claus reaction.

As with the system 200 of FIG. 8, downstream in the system 500 includes quenching with aqueous sulfurous acid to remove SO₂ and H₂S, and oxidation of excess aqueous sulfurous acid with oxygen gas in air to give sulfuric acid.

The Claus furnace 501 (a Claus-type reaction furnace) receives acid gas 521 having H₂S to combust the H₂S in a 1^{st} zone 501a of the furnace 501. The Claus furnace 501 converts H₂S into elemental S gas (vapor).

For H₂ production, elemental S and H₂O are heated in the sulfur burner 544, and the S is steam reformed in the sulfur steam reformer 547 (that receives the heated mixture of S and H₂O) to generate H₂ gas for recovery downstream. In implementations, the sulfur burner 544 and sulfur steam reformer 547 may be characterized as operationally in parallel with the Claus furnace 501.

For the systems of FIGS. 9 and 11, the stream 346, 546 exiting the sulfur burner (around 600° C.) may have a higher temperature (e.g., about 600° C.) and with more fluctuation. This is generally acceptable as long as the temperature of stream 346, 546 is above 445° C. and below 720° C.

As with sulfur burners previously discussed, the sulfur burner 544 has a combustion chamber for combusting sulfur, and a tube side to receive the combustion gases to heat gas components on the shell side. In operation, the sulfur burner 544 is fed and heats liquid water 523 and liquid elemental sulfur 524c on the shell side (outside of the heat exchanger tubes) of the sulfur burner 544 to a temperature of at least 445° C. The sulfur burner 544 discharges from the shell side a mixture 546 (as heated to at least 445° C.) of H₂O vapor and S gas to the sulfur steam reformer 547.

As with sulfur steam reformers discussed above, the sulfur steam reforming in the sulfur steam reformer 547 includes reacting the S gas with H₂O to generate H₂. The sulfur steam reformer 547 discharges a reformed mixture 548 (products of the sulfur steam reformer 547 including H₂) to an economizer 550. The economizer 550 cools the reformed mixture 548 to discharge the cooled reformed mixture 549 having the H₂.

The economizer 550 recovers heat from the reformed mixture 548 and transfers the heat to the liquid sulfur 524a to heat (pre-heat) the sulfur 524a to increase the temperature of the liquid sulfur 524a. The liquid sulfur 524a is provided to the economizer 550 from the sulfur pit 503 via the pump 518 (e.g., centrifugal pump). The liquid sulfur 524a as heated in the economizer 550 is fed as [1] heated liquid sulfur 524b for combustion in the sulfur burner 544 and as [2] heated liquid sulfur 524c on the shell side (outside the tubes) of the sulfur burner 544.

The heat in the sulfur burner 544 is provided via combustion (e.g., total combustion) of the liquid sulfur 524b with oxygen 520b in the combustion chamber and inside heat exchanger tubes (e.g., on the tube side) of the sulfur burner 544. In implementations, air can be fed to provide the oxygen 520b. The products of the combustion on the tube side in the sulfur burner 544 include SO₂ (and N₂ gas if air is the oxygen 520b source) and a relatively small amount of O₂ gas (e.g., <2 vol %). These combustion gases 545 may be conveyed (e.g., via a conduit) as discharged from the tube side of the sulfur burner 544 to the 1^{st} zone 501a of the Claus furnace 501.

As indicated, in the Claus furnace 501, the sour acid gas 521 (having H₂S as an acid gas) is burned (e.g., partially burned) with O₂ 520 (e.g., from fed air) and with O₂ gas of the combustion gases 545 in the 1^{st} zone 501a of the Claus furnace 501. A fuel gas 522, such as methane, can be added to the 1^{st} zone 501a to maintain the temperature of the furnace 501. The gases in the furnace 501 react in the 2^{nd} zone 501b of the Claus furnace 501 (a reaction furnace). As is typical in a Claus reaction furnace, reactions may include oxidation reactions (e.g., 2H₂S+3O₂→2SO₂+2H₂O) and the Claus reaction in which the Claus reaction furnace 501 converts H₂S into elemental S gas (vapor).

The furnace 501 gases are cooled (via water as cooling medium) in the heat exchanger part 501c of the Claus furnace 501c. The heat exchanger part 501c may be labeled as a boiler or WHB of the Claus furnace 501 (or associated with the Claus furnace 501). The heat exchanger part 501c may generate (produce) steam 525 (e.g., high-pressure steam in range of 600 psig to 1500 psig) from the water cooling medium on the side of the heat exchanger 501c opposite the furnace gases.

The furnace exhaust gas 526 (gases discharged from the furnace 501) and the cooled reformed mixture 549 having H₂ may be combined to give gas 551 fed to the condenser 502 (e.g., shell-and-tube heat exchanger). The condenser 502 generates (produces) steam 527 (e.g., low pressure steam <150 psig) by vaporizing the water cooling medium with heat from the gas 551. In the condenser 502, elemental S gas in the gas 551 is condensed (via the water cooling medium) and discharges as liquid sulfur 528, for example, to a sulfur pit 503. The entering gas 551 minus the condensed liquid sulfur 528 discharges from the condenser 502 as process gas 532 (cooler gases) to the quench tower 508. The process gas 532 is labeled as process gas in having H₂ to be recovered.

In implementations, heat tracing 507 may be disposed along the conduit conveying the process gas 532 to the quench tower 508 to prevent or reduce sulfur deposition from elemental S vapor in the process gas 532. As mentioned, heat tracing 507 may be, for example, electrical tracing or steam tracing. The heat tracing 507 may be a component of a heat tracing system.

The process gas 532 enters the quench tower 508, where the gas is cooled (e.g., to 60° C.) by passing the gas in countercurrent flow with aqueous sulfurous acid 534. The residual elemental S entrained in the process gas 532 may be transformed into soluble polythionic acid in presence of excess of sulfurous acid. Therefore, no (or little) solid is accumulated in the quench tower 508. The gas 540 (gas stream) that discharges overhead from the quench tower 508 includes the product H₂ gas along with CO₂. The gas 540 may additionally include N₂ gas if air is the oxygen 520 source to the upstream furnace 501. The discharged overhead gas 540 can be utilized as product or can be processed to further isolate the H₂ gas.

Makeup water 537 (e.g., demineralized water, steam condensate, etc.) may be added to the bottoms stream 509 (which can be labeled as water or aqueous sulfurous acid) that discharges from the bottom portion of the tower 508 to give water 534 (which can be aqueous sulfurous acid). The water 534 is sent via a pump 509 through an air cooler 510 heat exchanger to an upper part of the tower 508. The air cooler 510 may cool (with air as cooling medium) the water 534, for example, to a temperature less than 60° C.

A portion 550 of the water 534 upstream of the cooler 510 is sent to an upper part of an oxidation tower 551 vessel for flow downward in the tower 551 in a countercurrent flow direction with respect to the air 553 flowing upward through the tower 551. The air 553 may be introduced into a bottom part of the tower 551 via a blower 554 (e.g., centrifugal fan) (e.g., that receives ambient air or plant utility air). The oxygen gas in the air 553 may oxidize the aqueous sulfurous acid (H₂SO₃) in the tower 551 into H₂SO₄. The overhead gas 552 may include the air 553 minus the O₂ gas from the air 553 utilized (consumed) in the oxidation. The gas 552 discharging overhead from the tower 551 may include N₂ gas with some O₂ gas (e.g., 2-4 vol % of O₂).

Aqueous sulfuric acid 555 discharges (e.g., as a bottoms stream) from a bottom portion of the tower 551 and is sent through a membrane 556. The membrane 556 may be membrane system having a polymeric membrane, NF membrane, RO membrane, etc., and associated membrane system equipment. The membrane 556 discharges sulfuric acid 557 (e.g., more concentrated than the entering sulfuric acid 555) as retentate, and relatively pure or clean water 523 as permeate. A portion 558 of the sulfuric acid 557 (e.g., concentrated) is removed as product to be monetized. Another portion 559 of the concentrated sulfuric acid 557 is provided (e.g., conveyed via a conduit) to the furnace 501 to enrich the Claus furnace 501 in oxygen, in which aspects may be described in the U.S. Pat. No. 4,826,670, US Published Patent Application No. 2022/0177306A1, and US Published Patent Application No. 2022/0199908A1.

FIG. 12 is a hydrogen production system 600 that operates with an oxidative environment in the Clause furnace 2^{nd} zone 601b (and therefore no Claus catalytic converters), and employs indirect heating via an electric heater 644 or boiler for the sulfur steam reformer 647. The system 600 similar to the system 500 of FIG. 11, except that the system 600 employs an electric heater 644 (or boiler) instead of a sulfur burner to heat the S vapor and H₂O for the sulfur steam reformer 647. As in the system 500 of FIG. 11, the system 600 operates with an oxidative environment in the furnace 2^{nd} zone 601b, as mentioned.

The Claus furnace 601 (a Claus-type reaction furnace) receives acid gas 621 having H₂S to combust the H₂S in a 1^{st} zone 601a of the furnace 601. The Claus furnace 601 converts H₂S into elemental S gas (vapor). In the Claus furnace 1^{st} zone 601a, the sour acid gas 621 (having H₂S as an acid gas) is burned (e.g., partially burned) with O₂ 620 (e.g., from fed air). The sulfuric acid 659 may break down to provide O₂ for the combustion. In particular, the sulfuric acid 659 may first dehydrate to give SO₃, which decomposes to give SO₂ and O₂ in the Claus furnace. A fuel gas 622, such as methane, can be added to the 1^{st} zone 601a to maintain the temperature of the furnace 1^{st} zone 601a at a specified temperature value or within a specified temperature range. The gases in the furnace 601 react in the 2^{nd} zone 601b of the Claus furnace 601. The reactions may include the Claus reaction that converts H₂S and SO₂ into elemental S and H₂O.

As discussed for Claus furnaces in previous figures, the furnace 601 gas (a mixture of gases) is cooled (via water as cooling medium) in the heat exchanger part 601c of the Claus furnace 601c. The heat exchanger part 601c may generate (produce) steam 625 (e.g., high-pressure steam in range of 600 psig to 1500 psig) by vaporizing the water cooling medium on the side of the heat exchanger 601c opposite the furnace gas with heat from the furnace gas. The furnace gas as cooled in the heat exchanger part 601c (e.g., to less than or equal to 315° C.) discharges from the furnace 601 as furnace exhaust gas 626. The furnace exhaust gas 626 may include, for example, H₂S, SO₂, S, H₂O, and CO₂ (and N₂ if air is fed as the source of the O₂ 620).

For H₂ production, elemental sulfur 624b and water 623 are heated in the electric heater 644 (or boiler), and the S is steam reformed in the downstream sulfur steam reformer 647 (that receives the heated mixture of S and H₂O) to generate H₂ gas for recovery further downstream. In implementations, electric heaters may be disposed on or in the sulfur steam reformer 647 instead of having the upstream electric heater 644. In implementations, the electric heater 644 and sulfur steam reformer 647 may be characterized as operationally in parallel with the Claus furnace 601. The liquid water 623 and elemental sulfur 624b are heated (e.g., as a mixture) to a temperature of at least 450° C. or at least 500° C., or in a range of 450° C. to 550° C., by the electric heater 644 (or boiler). The heated mixture 646 of the water 623 and sulfur 624b discharges from the electric heater 644 to the sulfur steam reformer 647. The sulfur steam reforming in the sulfur steam reformer 647 includes reacting the S gas with H₂O vapor to generate H₂ gas. The sulfur steam reformer 647 discharges a reformed mixture 648 (products of the sulfur steam reformer 647 including H₂) to an economizer 650. The reformed mixture 648 may have a temperature, for example, of at least 600° C., or in a range of 550° C. to 700° C.

The three reactions immediately below may occur in the sulfur steam reformer. These three reactions immediately below may be considered steam reforming of sulfur. These three reactions immediately below may be exothermic to give the temperature increase (e.g., from inlet 500° C. to outlet 600° C.) through the sulfur steam reformer.

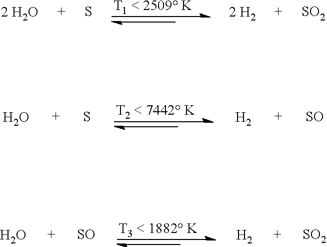

The economizer 650 cools the reformed mixture 648 to discharge the cooled reformed mixture 649 having the H₂. Liquid sulfur 624a is received by the economizer 650 from the sulfur pit 603 via the pump 618. In cooling the reformed mixture 648, the economizer 650 transfers heat from the reformed mixture 648 to the liquid sulfur 624a to heat (pre-heat) the sulfur 624a to increase the temperature of the liquid sulfur 624a. The liquid sulfur 624a from the economizer 350 as heated is fed as liquid sulfur 624b to the electric heater 644 (or boiler) to be further heated for the steam reforming in the sulfur steam reformer 647.

The furnace exhaust gas 626 and the cooled reformed mixture 649 (having H₂) may be combined to give gas 651 fed to the condenser 602 (e.g., shell-and-tube heat exchanger). In the condenser 602, elemental S gas in the gas 651 is condensed (via a water cooling medium) and discharges as liquid sulfur 628, for example, to the sulfur pit 603. The condenser 602 generates (produces) steam 627 (e.g., low pressure steam <150 psig) by vaporizing the water cooling medium with heat from the gas 651.

The gas 651 entering the condenser 602 minus the condensed liquid sulfur 628 discharges from the condenser 602 as process gas 632 (cooler gases) to the quench tower 608. The process gas 632 is labeled as process gas in having H₂ to be recovered. Heat tracing 607 (e.g., electrical tracing or steam tracing) may be disposed along the conduit conveying the process gas 632 to the quench tower 608 to prevent or reduce condensation or deposition of elemental S in the process gas 632.

The configuration and operation of the quench tower 608 and oxidation tower 651 systems are generally similar to the configuration and operation of the quench tower 508 and oxidation tower 551 systems of system 500 of FIG. 11.

The process gas 632 enters the quench tower 608, where the gas is cooled (e.g., to 60° C.) by passing the gas in countercurrent flow with aqueous sulfurous acid 634. Elemental S in the process gas 632 may be transformed into soluble polythionic acid in presence of excess of sulfurous acid in the quench tower 608. The overhead gas 640 that discharges from the quench tower 608 as a gas stream includes the product H₂ gas along with CO₂, and N₂ gas if air is the oxygen 620 source. Makeup water 637 (e.g., steam condensate, treated water, demineralized water, etc.) may be added to the bottoms stream 609 (water or aqueous sulfurous acid) that discharges from the bottom portion of the tower 608 to give water 634 (aqueous sulfurous acid). The water 634 is sent via a pump 609 through the air cooler 610 heat exchanger to an upper part of the quench tower 608. The air cooler 610 may cool (with air as cooling medium) the water 634, for example, to a temperature less than 60° C.

A portion 650 of the water 634 is sent to an upper part of an oxidation tower 651 vessel for flow downward in the tower 651 in a countercurrent flow direction with respect to the air 653 flowing upward through the tower 651. The air 653 may be introduced into a bottom part of the tower 651 via a blower 654 (e.g., centrifugal fan). The oxygen gas in the air 653 may oxidize the aqueous sulfurous acid (H₂SO₃) in the oxidation tower 651 into H₂SO₄. The overhead gas 652 may include the air 653 minus the O₂ gas from the air 653 utilized (consumed) in the oxidation. The overhead gas 652 discharge stream may include N₂ gas with some O₂ gas (e.g., 2-4 vol % of O₂).

Sulfuric acid 655 discharges (e.g., as a bottoms stream) from a bottom portion of the tower 651 and is sent through a membrane 656 system. The membrane 656 system may be a NF system or RO system. The membrane may be a polymeric membrane. The membrane 656 discharges sulfuric acid 657 (e.g., more concentrated than the entering sulfuric acid 655) as retentate, and relatively pure or clean water 623 as permeate. A portion 658 of the sulfuric acid 657 (e.g., concentrated) is removed as product to be monetized. Another portion 659 of the concentrated sulfuric acid 657 is provided (e.g., conveyed via a conduit) to the furnace 601 to enrich the Claus furnace 601 in oxygen.

FIGS. 13A and 13B are a hydrogen production system 700 in which a Claus furnace is not employed. Elemental sulfur 724b and water 723 are heated in an electric heater 744 (or boiler) for sulfur steam reforming in a downstream sulfur steam reformer 747 to generate H₂. Hydrogen sulfide 743 gas is fed to the electric heater 744 such that there is a reductive environment (excess H₂S) in the electric heater 744 and in the sulfur steam reformer 747. Acid gas having H₂S may be introduced to the hydrogen sulfide 743 stream to supplement the hydrogen sulfide 743 with additional H₂S.

The liquid water 723, liquid sulfur 724b, hydrogen sulfide 743 gas are heated separately by respective electric heaters 744 in parallel (or by boilers in parallel) to a temperature of at least 445° C., or in a range of 440° C. to 550° C. The water 723, sulfur 724b, and hydrogen sulfide 743, as heated and discharged from the heaters 744, combine to give a mixture 746 of water vapor, hydrogen sulfide, and sulfur vapor. The mixture 746 may have a temperature of at least 445° C., or in a range of 440° C. to 550° C. This mixture 746 is sent to the sulfur steam reformer 747 in which steam reforming of the elemental sulfur generates H₂.

The reformed mixture 748 (products of the sulfur steam reformer 747) discharged from the sulfur steam reformer 747 may be at a temperature, for example, of at least 600° C., or in a range of 550° C. to 700° C. The reformed mixture 748 may be sent to an economizer 750 that cools the reformed mixture 748 with liquid sulfur 724a as a cooling fluid to discharge the cooled reformed mixture 749 at a temperature less than 300° C., or in a range of 300° C. to 315° C. The Claus reaction may occur in the economizer 750, when the temperature drops below 445° C.

The liquid sulfur 724a may be provided to the economizer 750 via the pump 718 from the sulfur pit 703. The economizer 750 transfers heat from the reformed mixture 748 to the liquid sulfur 724a to heat (preheat) the liquid sulfur 724a to a temperature of at least 300° C., or in a range of 300° C. to 315° C., and give the liquid sulfur 724b as heated (preheated). As indicated, the liquid sulfur 724b is further heated in the electric heater 744 and sent in the mixture 746 to the sulfur steam reformer 747.

The cooled reformed mixture 749 discharged from the economizer 750 enters a condenser 702a (e.g., shell-and-tube heat exchanger). In the condenser 702a, elemental S gas in the cooled reformed mixture 749 is condensed (via a water cooling medium) and discharges as liquid sulfur 728, for example, to the sulfur pit 703. The condenser 702a generates (produces) steam 727a (e.g., low pressure steam <150 psig) by vaporizing the water cooling medium with heat from the cooled reformed mixture 749.

The cooled reformed mixture 749 that enters the condenser 702a minus the condensed liquid sulfur 728 discharges from the condenser 702 as process gas 729 (having the H₂ generated upstream in the sulfur steam reforming) at a temperature, for example, of less than 190° C., or in a range of 160° C. to 210° C. The gas 729 may have trace amounts of entrained elemental sulfur. The process gas 729 is sent through a reheater 704 heat exchanger to heat the process gas 729 to give the heated process gas 730 (which is the process gas 729 as heated). The reheater 704 heats the process gas 729 to give the process gas 730 at a temperature, for example, of at least 220° C., or in a range of 200° C. to 250° C., and that is fed to the hydrogenation reactor 706. The process gas 730 is sent to the hydrogenation reactor 706 from the reheater 704.

The hydrogenation reactor 706 may be analogous to the hydrogenation reactors 106, 306, and 406 of FIGS. 7A, 9A, and 10A, respectively. A portion of the H₂ in the heated process gas 730 is utilized to perform the hydrogenation in the reactor 706 (e.g., hydrogenation of SO₂ with H₂ to give H₂S).

The hydrogenated gas 731 (having H₂) discharged from the hydrogenation reactor 706 may have a temperature, for example, of at least 272° C., or in range of 240° C. to 320° C., and is cooled in the cooler 702c heat exchanger to a temperature less than 200° C. or less than 165° C. The gas 731 may generally not have S because of transformation of any S into H₂S in the hydrogenation reactor 706. The cooler 702b generates low pressure steam 727b (e.g., less than 150 psig) by vaporizing the liquid water utilized as the cooling medium. The exiting gas mixture from the cooler is 702b is process gas 732 and is further cooled in the heat exchanger 707 to give cooled process gas 733 (a cooler gas than the process gas 732) and generate low-low pressure steam (e.g., less than 60 psig). The cooled process gas 733 includes H₂, CO₂, H₂O, and H₂S. The source of the CO₂ in gas 733 may be from the acid gas introduced into stream 743. The gas 733 generally does not include N₂ because air is typically not fed to the system 700.

The configuration and operation of the quench tower 708 and selective amine treatment (including absorber 711 and the regeneration column 715, and associated equipment) are generally similar to the configuration and operation of such equipment and processes discussed with respect to FIGS. 7B, 9B, and 10B.

The cooled process gas 733 enters the quench tower 708 and flows upward in a countercurrent flow direction with respect to water 734 flowing downward in the quench tower 708. The water 734 is cooler than the cooled process gas 733. Thus, water vapor in the process gas 733 is condensed in the quench tower 708.

Liquid water 735 including this condensed water discharges (e.g., as a bottoms stream) from a bottom part of the tower 708. Some of the water 735 is sent with any added water 737 as the water 723 through an electric heater 744 to the sulfur steam reformer 747. Some of the water 735 is routed as the water 734 via the pump 709 (e.g., a centrifugal pump) through an air cooler 710 heat exchanger as recycle to an upper part of the tower 708 for flow downward in the quench tower 708. The water 734 may be considered as quench water, and that condenses or absorbs water from the process gas 733 flowing upward through the quench tower 708.

The overhead gas 738 that discharges overhead from the quench tower 708 is generally the cooled process gas 733 entering the tower 708 minus the water vapor in the process gas 733 that is condensed in the tower 708. This overhead gas 738 discharged from a top portion of the quench tower 308 includes H₂, H₂S, and CO₂.

The overhead gas 738 may be sent to a gas sweetening unit (an amine treating system that is a selective amine process) to separate the H₂S from the H₂ in the overhead gas 738, as generally discussed with respect to the amine treatment system of FIGS. 7B, 9B, and 10B. The amine treating system includes the absorber 711 and the regeneration distillation column 715 (also called a desorber). An applicable example amine-treatment system (a selective amine process) in depicted in FIG. 16.

A gas 743 enriched in H₂S (e.g., at least 70 vol % H₂S) discharges overhead from the regeneration distillation column 715. This gas 743 may be primarily H₂S, and may include a relatively small amount CO₂ in addition to the H₂S. The gas 743 is sent through an electric heater 744 (or boiler) to the sulfur steam reformer 747. Intermediate product gas 740 having H₂ product and CO₂ discharges overhead as a gas stream from the absorber 711 column vessel. The H₂ gas can be extracted and purified. The amine treating system (a selective amine process) includes pumps 712, 717 and heat exchangers 713, 714, 716, as discussed with respect to FIGS. 7B, 9B, and 10B.

FIG. 14 is a hydrogen production system 800 in which a Claus furnace is not employed. Elemental sulfur 824b and water 823 are heated to at least 445° C. (or in a range of 440° C. to 550° C.) in separate electric heaters 844 (or boilers) in parallel for sulfur steam reforming in a downstream sulfur steam reformer 847 to generate H₂. A mixture of the sulfur 820 and water 823 may be the same electric heater. However, a reason for heating these two streams in different electric heaters, respectively, is the two streams do not have the same boiling points. Therefore, separate heating the sulfur 820 and water 823, respectively, may give better control of the heating process. Hydrogen sulfide is not fed to sulfur reformer 847 such that there is an oxidative environment (excess SO₂) in the sulfur steam reformer 847.

The water 823 and sulfur 824b discharged from the heaters 844 are combined to give a mixture 846 of H₂O vapor and S vapor. The mixture 846 may have a temperature of at least 445° C. (or in a range of 440° C. to 550° C.). The mixture 846 is sent to the sulfur steam reformer 847 in which steam reforming of the elemental S generates H₂.

The reformed mixture 848 (products of the sulfur steam reformer 847) discharged from the sulfur steam reformer 847 may be at a temperature, for example, of at least 600° C., or in a range of 550° C. to 700° C. The reformed mixture 848 may include H₂ and SO₂ generated in the steam reforming of the sulfur, and include S and H₂O not reacted in the steam reformer 847. The reformed mixture 848 may be sent to an economizer 850 that cools the reformed mixture 848 with liquid sulfur 824a as a cooling fluid to discharge the cooled reformed mixture 849 at a temperature less than 300° C., or in a range of 300° C. to 315° C.

As discussed for the liquid sulfur 724a in FIG. 13A, the liquid sulfur 824a may be provided to the economizer 850 via the pump 818 from the sulfur pit 803. The economizer 850 transfers heat from the reformed mixture 848 to the liquid sulfur 824a to heat (preheat) the liquid sulfur 824a to a temperature of at least 300° C., or in a range of 300° C. to 315° C., and give the liquid sulfur 824b as heated (preheated). As indicated, the liquid sulfur 824b is further heated in an electric heater 844 and sent in the mixture 846 to the sulfur steam reformer 847.

The cooled reformed mixture 849 discharged from the economizer 850 is conveyed via a conduit to the condenser 802 heat exchanger (e.g., shell-and-tube heat exchanger). In the condenser 802, elemental S gas in the cooled reformed mixture 849 is condensed (via a water cooling medium) and discharges as liquid sulfur 828, for example, to the sulfur pit 803. The condenser 802 generates (produces) steam 827 (e.g., low pressure steam <150 psig) by vaporizing the water cooling medium with heat from the cooled reformed mixture 849.

The cooled reformed mixture 849 that enters the condenser 802 minus the condensed liquid sulfur 828 discharges from the condenser 802 as process gas 832 (having the H₂ generated upstream in the sulfur steam reforming). The process gas 832 includes H₂, H₂O, SO₂, and traces of S vapor. The process gas 832 is sent to the quench tower 808. Heat tracing 807 may situated along the conduit conveying the process gas 832 to the quench tower 808 to prevent or reduce deposition of any elemental S entrained in the process gas 832.

The process gas 832 is introduced into a lower part of the quench tower 808 and flows upward in a counter current flow direction with respect to the water 834 (as quench water) flowing downward through the quench tower 808. The water 834 may be aqueous sulfurous acid. The SO₂ in the process gas 832 may be absorbed by the water 834 in the quench tower 808, giving the water 834 as sulfurous acid. Elemental S in the process gas 832 may be transformed into soluble polythionic acid in presence of excess of sulfurous acid in the quench tower 808.

The overhead gas 840 that discharges from the quench tower 808 may be primarily H₂ gas, such as at least 90 vol % H₂. The overhead gas 840 (discharged as a gas stream) may be considered a product stream. The overhead gas 840 may be processed to further in increase the H₂ purity.

Makeup water 837 may be added to the bottoms stream 809 (water or aqueous sulfurous acid) that discharges from the bottom portion of the tower 808 to give water 834 (aqueous sulfurous acid). The water 834 is sent via a pump 809 through the air cooler 810 heat exchanger to an upper part of the quench tower 808. The air cooler 810 may cool (with air as cooling medium) the water 834, for example, to a temperature less than 60° C.

A portion 850 of the water 834 (sulfurous acid) is sent to an upper part of an oxidation tower 851 vessel for flow downward in the oxidation tower 851 in a countercurrent flow direction with respect to the air 853 flowing upward through the tower 851. The air 853 may be introduced into a bottom part of the tower 851 via a blower 854 (e.g., centrifugal fan). The oxygen gas in the air 853 may oxidize the aqueous sulfurous acid (H₂SO₃) in the oxidation tower 851 into H₂SO₄. The overhead gas 852 may include the air 853 minus the O₂ gas from the air 853 utilized (consumed) in the oxidation in the tower 851. The overhead gas 852 discharge stream may include N₂ gas with some O₂ gas (e.g., 2-4 vol % of 02).

Sulfuric acid 855 discharges (e.g., as a bottoms stream) from a bottom portion of the oxidation tower 851 and is sent through a membrane 856 system, as previously discussed. The membrane 856 discharges sulfuric acid 857 (e.g., more concentrated than the entering sulfuric acid 855) as retentate, and relatively pure or clean water 823 as permeate. The sulfuric acid 857 (e.g., concentrated) may be removed as product to be monetized. As discussed, the liquid water 823 is sent through an electric heater 844 to be included in the mixture 846 sent to the sulfur steam reformer 847.

General comments regarding the foregoing figures are provided. A reductive environment means that H₂S in excess is present at the outlet of the sulfur steam reformer. The SO₂ produced by the steam reforming of sulfur is reduced to sulfur by the excess of H₂S. The oxidative environment means that SO₂ in excess is present at the outlet of the sulfur steam reformer. The sulfur vapor is oxidized to SO₂ by water. The excess of H₂S may be molar excess with respect to SO₂. The excess of SO₂ may be molar excess with respect to H₂S. The reductive environment in FIG. 13A is via stream 743 as acid gas containing H₂S and with an excess of H₂S is found in the stream 748, which makes this a reductive environment. The oxidative environment in FIG. 14 is stream 848 containing SO₂ (from the reaction), which makes this an oxidative environment. The Claus reaction may occur in the sulfur steam reformer in reductive environment of FIGS. 9A, 10A, and 13A, but not in oxidative environment of FIGS. 11, 12, and 14. The Claus reaction generally does not occur in the sulfur steam reformers 347, 447, 547, 647, 747, 847 because the temperature is above the boiling point of sulfur (445° C.).

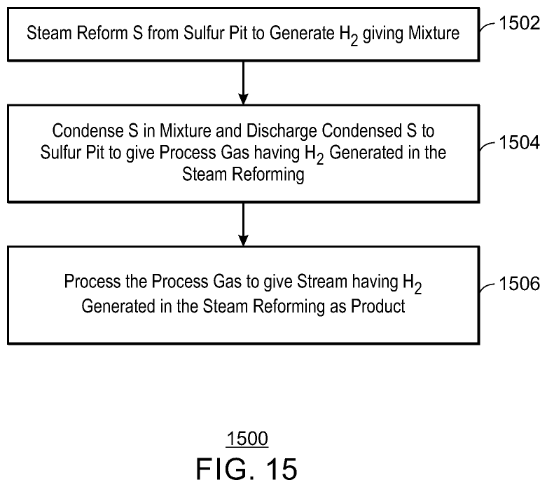

FIG. 15 is a method 1500 of producing hydrogen (H₂) gas. The method involves steam reforming elemental S to generate the H₂. The produced H₂ can be utilized in the transportation and energy sector. The produced H₂ can be feedstock for chemical processes, electrochemical processes, and the like. The elemental S reformed includes elemental S from a sulfur pit. As known by one of ordinary skill in the art, the sulfur pit in the present context is a sulfur receiver, which can include a receptacle, container, or vessel, and so on. The sulfur receiver or sulfur pit may be a storage vessel in which liquid sulfur is accumulated and stored. A sulfur pit may temporarily accommodate elemental S extracted from an SRU or similar system, and in which the elemental sulfur may then be conveyed from the sulfur pit for further processing or to transportation systems, and the like.

At block 1502, the method includes steam reforming elemental S, such as from a sulfur pit. A reaction in the steam reforming can include 2H₂O+S→2H₂+SO₂. Therefore, H₂ gas and SO₂ are generated in the steam reforming. Additional reactions may occur. The steam reforming of the S may give a mixture including H₂ gas, SO₂, elemental S gas, and H₂O vapor. The elemental S and H₂O vapor in the mixture may be or include unreacted components from the steam reforming.

To perform (block 1502) (see, e.g., the systems in FIGS. 7A-8) the steam reforming, the method may include injecting the elemental sulfur from the sulfur pit into an intermediate zone (e.g., second zone) of a furnace (e.g., Claus furnace or Claus-type furnace), injecting water into the intermediate zone, performing the steam reforming in the intermediate zone, and discharging furnace exhaust gas from the furnace as the aforementioned mixture. The mixture may be discharged to a condenser. In implementations, the intermediate zone of the furnace can be characterized or labeled as a sulfur steam reformer (not stand-alone but integrated within the furnace). The method may include feeding oxygen gas and acid gas including hydrogen sulfide and carbon dioxide to the furnace for combustion in a first zone of the furnace. If so, the mixture discharged from the furnace may include carbon dioxide. Further, the method may include heating in the intermediate zone the elemental sulfur injected into the intermediate zone and the water injected into the intermediate zone by direct contact with combustion gas (furnace gas) from the first zone flowing into the intermediate zone. In implementations, the method 1500 of producing hydrogen can involve generally producing the hydrogen in a sulfur recovery unit (SRU) having the furnace.

To perform (block 1502) (see, e.g., the systems in FIGS. 9-14) the steam reforming, the method may include providing the elemental sulfur from the sulfur pit to a vessel that is a sulfur steam reformer, providing water to the vessel, performing the steam reforming of elemental sulfur in the vessel, and discharging from the vessel the mixture having H₂ gas, SO₂, elemental S gas, and H₂O vapor. The mixture may be discharged to a condenser. The providing of the elemental sulfur may involve heating the elemental sulfur in an economizer (a heat exchanger) with heat from the mixture discharged from the vessel. If so, the method may include discharging the mixture from the vessel (sulfur steam reformer) through the economizer to the condenser (also a heat exchanger). The providing of the elemental sulfur (and the water) may involve heating the elemental sulfur (and the water) upstream of the vessel (sulfur steam reformer), wherein the heating includes heating the elemental sulfur (and the water) in an electric heater, a boiler, or a sulfur burner. The method (e.g., see the systems in FIGS. 9-12) may include providing oxygen gas and acid gas including hydrogen sulfide and carbon dioxide to a furnace, and discharging furnace exhaust gas (including CO₂) from the furnace to combine with the mixture flowing sulfur steam reformer to the condenser. In implementations, the method 1500 of producing hydrogen may be producing hydrogen in an SRU having the vessel (sulfur steam reformer) and the furnace (e.g., Claus furnace or Claus-type furnace).

At block 1504 (see, e.g., the systems in FIGS. 7A-14), the method includes condensing elemental sulfur gas in the mixture (from the steam reforming) in the condenser into liquid elemental sulfur, and discharging liquid elemental sulfur from the condenser, such as to the sulfur pit. The method includes discharging a process gas from the condenser, wherein the process gas includes H₂ gas and SO₂ generated in the steam reforming. The process gas generally does not include the liquid elemental sulfur discharged from the condenser to the sulfur pit.

At block 1506 (see, e.g., the systems in FIGS. 7A-14), the method includes processing the process gas to give a stream having the H₂ generated in the steam reforming as product. For instance (see, e.g., FIGS. 8, 11, 12, and 15), the method at block 1506 may include quenching the process gas in a quench tower with water to absorb SO₂ from the process gas into the water to discharge overhead from the quench tower a gas stream having hydrogen gas from the steam reforming as product. Such may be applied in conjunction with a reductive environment (excess H₂S) in the upstream steam reforming (block 1502) in certain implementations. In another embodiment (e.g., FIGS. 13A and 13B), the method at block 1506 may include hydrogenating the process gas to convert sulfur dioxide in the process gas into hydrogen sulfide to give a hydrogenated process gas (having H₂ generated in the upstream reforming), quenching the hydrogenated process gas with water to remove water vapor from the hydrogenated process gas, and absorbing hydrogen sulfide from the hydrogenated process gas into liquid amine to give a stream having H₂ generated in the steam reforming as product.

The method at block 1506 may include catalytic converting hydrogen sulfide and sulfur dioxide in the process gas into elemental S and removing elemental S to give a second process gas having H₂ generated in the steam reforming (block 1502). The method may include hydrogenating SO₂ in the second process gas into H₂S to give a third process gas (hydrogenated process gas) having the H₂S formed in the hydrogenating and H₂ generated in the steam reforming. The method may include quenching the third process gas with water to remove water vapor from the third process gas, and absorbing H₂S from the third process gas into liquid amine to give a stream having H₂ generated in the steam reforming as product. In particular, the method may include: [1] quenching the third process gas with water in a quench tower to remove water vapor from the third process gas; [2] discharging an overhead gas from the quench tower to an absorber column, wherein the overhead gas includes the third process gas without the water vapor removed from the third process gas in the quench tower; [3] absorbing H₂S from the overhead gas into liquid amine in the absorber column; and [4] discharging overhead from the absorber column a stream having H₂S generated in the steam reforming (block 1502) as product. For block 1506, see, e.g., FIGS. 7A, 7B, 9A, 9B, 10A, and 10B

FIG. 16 is an example of a system that implements amine treatment of sour gas, also known as amine scrubbing, gas sweetening (a gas sweetening unit), and H₂S removal. The system may be a selective amine process that separates (removes) H₂S from sour gas to give sweet gas. This amine treatment may be employed to treat SRU tail gas (Claus tail gas)

FIG. 16 may be an example of a selective amine process that may be implemented in the hydrogen production systems of FIGS. 7B, 9B, 10B, and 13B. The absorber depicted in FIG. 16 may be analogous to the absorber 111, 311, 411, 711, and the regenerator depicted in FIG. 16 analogous to the regeneration column 115, 315, 415, 715.

The system depicted in FIG. 16 employs an aqueous solution of an alkylamine(s) (referred to as amine) to remove H₂S from sour gas. A gas may be labeled as “sour” gas because of the presence of H₂S in the gas. The depicted sour gas entering the system may be analogous to the overhead gas 138, 338, 438, 738 (a process gas having H₂S and H₂) that discharges overhead from the quench tower 108, 338, 408, 708 in FIGS. 7B, 9B, 10B, and 13B.

Amines utilized in the gas sweetening unit (selective amine process) may include diethanolamine (DEA), monoethanolamine (MEA), methyldiethanolamine (MDEA), diisopropanolamine (DIPA), and aminoethoxyethanol (Diglycolamine) (DGA). Amines commonly employed are the alkanolamines DEA, MEA, and MDEA.

In the context of FIGS. 7B, 9B, 10B, and 13B, the gas (e.g., process gas) having H₂ and H₂S (and CO₂) is treated in the sweetening unit of FIG. 16 to remove the H₂S. The resulting dissociated and ionized species being more soluble in solution are scrubbed by the amine solution and thus removed from the gas phase. At the outlet of the amine scrubber, the gas as sweetened is thus depleted in H₂S.

The chemistry in the amine treating may vary in particular with the amine. The absorption of H₂S into liquid amine is well known, as well as widely used to remove selectively H₂S in oil and gas industry before sending this H₂S stream to SRU. As an example, for MDEA denoted as CH₃R₂N with R: —CH₂CH₂OH, the acid-base reaction involves protonation of the amine electron pair to form a positively charged ammonium group CH₃R₂NW, and which can be represented by CH₃R₂N+H₂S=CH₃R₂NH⁺+HS⁻.

There are also examples of the amine not being MDEA, for instance, as indicated in CH₃R₂N+H₂CO₃=CH₃R₂NH⁺+HCO₃⁻ that is associated with absorbing CO₂ into the amine.

The chemical structure of the selective amine MDEA is not suited to form a carbamate, does not have a proton on the nitrogen, and can only sequester dissolved CO₂ (or carbonic acid) via deprotonation. Similarly, this amine will capture H₂S via deprotonation. The rate of gas dissolution in amine solution (H₂S being faster than CO₂) is large enough that, using the residence time and absorber temperature, the selective amine process can separate with high selectivity H₂S from CO₂.

The system depicted in FIG. 16 is only an example a typical amine gas treating process and includes an absorber column and a regenerator distillation column. The sour gas enters a bottom portion of the absorber column (vessel) and flows upward through the absorber column. An aqueous solution of amine enters a top portion of the absorber column and flows downward through the absorber column in a countercurrent direction with respect to the sour gas flowing upward. This amine solution that enters the absorber column may be labeled as lean amine in having little or no H₂S. The absorber column may have trays as indicated, or may have packing, to provide surface area for contact of the lean amine with the sour gas and thus give mass transfer stages for absorption of acid gas from the sour gas into the lean amine. Sweet gas (e.g., analogous to intermediate product 140, 340, 440, 740) having little or no H₂S discharges overhead from the absorber column for use or further processing. Rich amine (rich in H₂S by having the H₂S absorbed from the sour gas) discharges from a bottom portion of the absorber column. In the illustrated example, a liquid level of the rich amine solution may be maintained in the bottom portion of the absorber column via a control valve and a level sensor.

The rich amine may flow to the regenerator (regenerator distillation column) that removes the H₂S from the rich amine to discharge the lean amine from a bottom portion of the regenerator. An overhead gas with removed H2S may discharge overhead from the regenerator and be partially condensed. Reflux may be sent via a reflux drum (vessel) and a reflux pump (e.g., centrifugal pump) to the regenerator. H2S (e.g., analogous the H2S 143, 343, 443, 743) may discharge from the system as gas from the vapor space of the reflux drum. The H2S may be sent, for instance, to a sulfur burner or an SRU (e.g., Claus process system) in which the H2S is converted to elemental sulfur. The lean amine discharges from a bottom portion of the regenerator. The regenerator includes a steam reboiler to vaporize a portion of the lean amine for return to the regenerator. The liquid amine is pumped through a cross exchanger (cooled by the rich amine) and a cooler heat exchanger (e.g., cooling water is cooling medium) for supply to the absorber column.

An embodiment is a method of producing hydrogen. The method includes steam reforming elemental sulfur from a sulfur pit, thereby generating hydrogen gas and sulfur dioxide, to give a mixture including hydrogen gas, sulfur dioxide, elemental sulfur gas, and water vapor. The steam reforming of elemental sulfur may be performed, for example, at a temperature in a range of 445° C. to 720° C. The method includes condensing elemental sulfur gas in the mixture in a condenser (heat exchanger) into liquid elemental sulfur and discharging liquid elemental sulfur from the condenser to the sulfur pit. The method includes discharging a process gas from the condenser, wherein the process gas includes hydrogen gas and sulfur dioxide generated in the steam reforming, and generally does not include the liquid elemental sulfur discharged from the condenser to the sulfur pit.

In implementations, the method may include quenching the process gas in a quench tower with water to absorb sulfur dioxide from the process gas into the water to discharge overhead from the quench tower a gas stream including hydrogen gas from the steam reforming as product.

In implementations, the method includes hydrogenating the process gas to convert sulfur dioxide in the process gas into hydrogen sulfide to give a hydrogenated process gas having hydrogen gas generated in the steam reforming as product, quenching the hydrogenated process gas with water to remove water vapor from the hydrogenated process gas, and absorbing hydrogen sulfide from the hydrogenated process gas into liquid amine to give a stream including hydrogen gas generated in the steam reforming as product.

In implementations, the method includes catalytic converting hydrogen sulfide and sulfur dioxide in the process gas into elemental sulfur and removing elemental sulfur to give a second process gas comprising hydrogen gas generated in the steam reforming. If so, the method may include hydrogenating sulfur dioxide in the second process gas into hydrogen sulfide to give a third process gas having the hydrogen sulfide formed in the hydrogenating and hydrogen gas generated in the steam reforming. The method may include quenching the third process gas with water to remove water vapor from the third process gas, and absorbing hydrogen sulfide from the third process gas into liquid amine to give a stream comprising hydrogen gas generated in the steam reforming as product. The method may include quenching the third process gas with water in a quench tower to remove water vapor from the third process gas, and discharging an overhead gas from the quench tower to an absorber column, the overhead gas including the third process gas without the water vapor removed from the third process gas in the quench tower, absorbing hydrogen sulfide from the overhead gas into liquid amine in the absorber column, and discharging overhead from the absorber column a stream comprising hydrogen gas generated in the steam reforming as product.

In implementations, the method includes injecting the elemental sulfur from the sulfur pit into an intermediate zone of a furnace and injecting water into the intermediate zone, wherein the steam reforming is performed in the intermediate zone, and discharging the mixture that is furnace exhaust gas from the furnace to the condenser. The method may include feeding oxygen gas and acid gas including hydrogen sulfide and carbon dioxide to the furnace for combustion in a first zone of the furnace, wherein the furnace exhaust gas thus includes carbon dioxide. The method may include heating the elemental sulfur injected into the intermediate zone and the water injected into the intermediate zone by direct contact with combustion gas from the first zone. In these implementations, the method of producing hydrogen may be producing hydrogen in a sulfur recovery unit (SRU) having the furnace.

In implementations, the method may include providing the elemental sulfur from the sulfur pit to a vessel that is a sulfur steam reformer and providing water to the vessel, wherein the steam reforming is performed in the vessel, and discharging the mixture from the vessel to the condenser. The providing of the elemental sulfur may involve heating the elemental sulfur in an economizer (heat exchanger) with heat from the mixture discharged from the vessel, and wherein discharging the mixture includes discharging the mixture from the vessel through the economizer to the condenser. The providing of the elemental sulfur may involve heating the elemental sulfur upstream of the vessel, wherein the heating includes heating the elemental sulfur in an electric heater, a boiler, or a sulfur burner. The providing of the water may involve heating the water upstream of the vessel, wherein the heating includes heating the water in an electric heater, a boiler, or a sulfur burner. The method may include providing oxygen gas and acid gas including hydrogen sulfide and carbon dioxide to a furnace, and discharging furnace exhaust gas from the furnace to combine with the mixture flowing to the condenser, wherein the furnace exhaust gas includes carbon dioxide. If so, the method of producing hydrogen may be producing hydrogen in a sulfur recovery unit (SRU) having the vessel and the furnace.

Another embodiment is a hydrogen production system including a vessel (e.g., furnace or stand-alone sulfur steam reformer) configured to receive elemental sulfur from a sulfur pit and steam reform the elemental sulfur into hydrogen gas and sulfur dioxide, and discharge a mixture having hydrogen gas, sulfur dioxide, elemental sulfur gas, and water vapor. The hydrogen production system includes a condenser heat exchanger to receive the mixture and condense elemental sulfur gas in the mixture into liquid elemental sulfur, and discharge liquid elemental sulfur to the sulfur pit and discharge a process gas having hydrogen gas and sulfur dioxide generated via steam reforming in the vessel.

In implementations, the hydrogen production system includes a quench tower to quench the process gas with water to remove water vapor from the process gas and discharge an overhead gas comprising hydrogen gas generated in the steam reforming to an absorber column as product.

In implementations, the hydrogen production system includes: [A] catalytic stages to convert hydrogen sulfide and sulfur dioxide in the process gas into elemental sulfur and remove elemental sulfur to give a second process gas having hydrogen gas generated in the steam reforming, wherein the catalytic stages each included a catalytic converter and a condenser heat exchanger; [B] a hydrogenation reactor to hydrogenate sulfur dioxide in the second process gas into hydrogen sulfide to give a third process gas comprising the hydrogen sulfide formed in the hydrogenation reactor and hydrogen gas generated in the steam reforming; [C] a quench tower to quench the third process gas with water to remove water vapor from the third process gas and discharge an overhead gas comprising hydrogen gas generated in the steam reforming to an absorber column; and [D] the absorber column configured to absorb hydrogen sulfide from the overhead gas from the quench tower into liquid amine to give an overhead stream from the absorber column comprising hydrogen gas from the steam reforming as product.

In implementations, the vessel is a furnace having an intermediate zone to receive the elemental sulfur and water to steam reform the elemental sulfur, wherein the furnace is configured to receive acid gas and oxygen gas for combustion in a first zone of the furnace and to heat the elemental sulfur and water in the intermediate zone with combustion gas from the first zone, and wherein the mixture discharged includes carbon dioxide. The hydrogen production system may be or include a SRU having the furnace and catalytic stages each including a catalytic reactor and a condenser heat exchanger, wherein a first catalytic stage of the catalytic stages is configured to receive the process gas.

In implementations, the vessel is a sulfur steam reformer that receives the elemental sulfur and water to steam reform the elemental sulfur and discharge the mixture to the condenser. The hydrogen production system may include an economizer that is a heat exchanger configured to receive the elemental sulfur from the sulfur pit and heat the elemental sulfur with heat from the mixture discharged from the sulfur steam reformer through the economizer to the condenser, wherein the economizer is configured to discharge the elemental sulfur as heated for the sulfur steam reformer. The hydrogen production system may include a heater operationally disposed between the sulfur pit and the sulfur steam reformer to heat the elemental sulfur upstream of the sulfur steam reformer, wherein the heater includes an electric heater, a boiler, or a sulfur burner. The hydrogen production system may include a furnace (in addition to the vessel) to receive acid gas and oxygen and discharge furnace exhaust gas to combine with the mixture flowing to the condenser, wherein the furnace exhaust gas includes carbon dioxide. The hydrogen production may be or include an SRU having the furnace and catalytic stages each comprising a catalytic reactor and a condenser heat exchanger, wherein a first catalytic stage of the catalytic stages is configured to receive the process gas.

A number of implementations have been described. Nevertheless, it will be understood that various modifications may be made without departing from the spirit and scope of the disclosure.

What is claimed is:

1. A method of producing hydrogen, comprising:
steam reforming elemental sulfur from a sulfur pit, thereby generating hydrogen gas and sulfur dioxide, to give a mixture comprising hydrogen gas, sulfur dioxide, elemental sulfur gas, and water vapor;
condensing elemental sulfur gas in the mixture in a condenser into liquid elemental sulfur and discharging liquid elemental sulfur from the condenser to the sulfur pit, wherein the condenser comprises a heat exchanger; and
discharging a process gas from the condenser, wherein the process gas comprises hydrogen gas and sulfur dioxide generated in the steam reforming.

2. The method of claim 1, wherein the steam reforming of the elemental sulfur is performed at a temperature in a range of 445° C. to 720° C., and wherein the process gas does not comprise the liquid elemental sulfur discharged from the condenser to the sulfur pit.

3. The method of claim 1, comprising:
injecting the elemental sulfur from the sulfur pit into an intermediate zone of a furnace;
injecting water into the intermediate zone, wherein the steam reforming is performed in the intermediate zone; and
discharging the mixture that is furnace exhaust gas from the furnace to the condenser.

4. The method of claim 3, comprising:
feeding oxygen gas and acid gas comprising hydrogen sulfide and carbon dioxide to the furnace for combustion in a first zone of the furnace; and
heating the elemental sulfur injected into the intermediate zone and the water injected into the intermediate zone by direct contact with combustion gas from the first zone, wherein the furnace exhaust gas comprises carbon dioxide.

5. The method of claim 4, wherein the method of producing hydrogen comprises producing hydrogen in a sulfur recovery unit (SRU) comprising the furnace.

6. The method of claim 1, comprising:
providing the elemental sulfur from the sulfur pit to a vessel that is a sulfur steam reformer;
providing water to the vessel, wherein the steam reforming is performed in the vessel; and
discharging the mixture from the vessel to the condenser.

7. The method of claim 6, wherein providing the elemental sulfur comprises heating the elemental sulfur in an economizer comprising a heat exchanger with heat from the mixture discharged from the vessel, and wherein discharging the mixture comprises discharging the mixture from the vessel through the economizer to the condenser.

8. The method of claim 6, wherein providing the elemental sulfur comprises heating the elemental sulfur upstream of the vessel, and wherein the heating comprises heating the elemental sulfur in an electric heater, a boiler, or a sulfur burner.

9. The method of claim 6, wherein providing the water comprises heating the water upstream of the vessel, and wherein the heating comprises heating the water in an electric heater, a boiler, or a sulfur burner.

10. The method of claim 6, comprising:
providing oxygen gas and acid gas comprising hydrogen sulfide and carbon dioxide to a furnace; and
discharging furnace exhaust gas from the furnace to combine with the mixture flowing to the condenser, wherein the furnace exhaust gas comprises carbon dioxide.

11. The method of claim 10, wherein the method of producing hydrogen comprises producing hydrogen in a sulfur recovery unit (SRU) comprising the vessel and the furnace.

12. The method of claim 1, comprising quenching the process gas in a quench tower with water to absorb sulfur dioxide from the process gas into the water to discharge overhead from the quench tower a gas stream comprising hydrogen gas from the steam reforming as product.

13. The method of claim 1, comprising:
hydrogenating the process gas to convert sulfur dioxide in the process gas into hydrogen sulfide to give a hydrogenated process gas comprising hydrogen gas generated in the steam reforming as product;
quenching the hydrogenated process gas with water to remove water vapor from the hydrogenated process gas; and
absorbing hydrogen sulfide from the hydrogenated process gas into liquid amine to give a stream comprising hydrogen gas generated in the steam reforming as product.

14. The method of claim 1, comprising:
catalytic converting hydrogen sulfide and sulfur dioxide in the process gas into elemental sulfur and removing elemental sulfur to give a second process gas comprising hydrogen gas generated in the steam reforming; and
hydrogenating sulfur dioxide in the second process gas into hydrogen sulfide to give a third process gas comprising the hydrogen sulfide formed in the hydrogenating and hydrogen gas generated in the steam reforming.

15. The method of claim 14, comprising quenching the third process gas with water to remove water vapor from the third process gas, and absorbing hydrogen sulfide from the third process gas into liquid amine to give a stream comprising hydrogen gas generated in the steam reforming as product.

16. The method of claim 14, comprising:
quenching the third process gas with water in a quench tower to remove water vapor from the third process gas;
discharging an overhead gas from the quench tower to an absorber column, the overhead gas comprising the third process gas without the water vapor removed from the third process gas in the quench tower;
absorbing hydrogen sulfide from the overhead gas into liquid amine in the absorber column; and
discharging overhead from the absorber column a stream comprising hydrogen gas generated in the steam reforming as product.

17. A hydrogen production system comprising:
a vessel configured to receive elemental sulfur from a sulfur pit and steam reform the elemental sulfur into hydrogen gas and sulfur dioxide, and discharge a mixture comprising hydrogen gas, sulfur dioxide, elemental sulfur gas, and water vapor; and
a condenser heat exchanger to receive the mixture and condense elemental sulfur gas in the mixture into liquid elemental sulfur, and discharge liquid elemental sulfur to the sulfur pit and discharge a process gas comprising hydrogen gas and sulfur dioxide generated via steam reforming in the vessel.

18. The system of claim 17, wherein the vessel comprises a furnace having an intermediate zone to receive the elemental sulfur and water to steam reform the elemental sulfur, wherein the furnace is configured to receive acid gas and oxygen gas for combustion in a first zone of the furnace and to heat the elemental sulfur and water in the intermediate zone with combustion gas from the first zone, and wherein the mixture comprises carbon dioxide.

19. The system of claim 18, comprising a sulfur recovery unit (SRU) comprising the furnace and catalytic stages each comprising a catalytic reactor and a condenser heat exchanger, wherein a first catalytic stage of the catalytic stages is configured to receive the process gas.

20. The system of claim 17, wherein the vessel comprises a sulfur steam reformer to receive the elemental sulfur and water to steam reform the elemental sulfur and discharge the mixture to the condenser.

21. The system of claim 20, comprising an economizer that is a heat exchanger configured to receive the elemental sulfur from the sulfur pit and heat the elemental sulfur with heat from the mixture discharged from the sulfur steam reformer through the economizer to the condenser, wherein the economizer is configured to discharge the elemental sulfur as heated for the sulfur steam reformer.

22. The system of claim 20, comprising a heater operationally disposed between the sulfur pit and the sulfur steam reformer to heat the elemental sulfur upstream of the sulfur steam reformer, wherein the heater comprises an electric heater, a boiler, or a sulfur burner.

23. The system of claim 20, comprising a furnace to receive acid gas and oxygen and discharge furnace exhaust gas to combine with the mixture flowing to the condenser, wherein the furnace exhaust gas comprises carbon dioxide.

24. The system of claim 23, comprising a sulfur recovery unit (SRU) comprising the furnace and catalytic stages each comprising a catalytic reactor and a condenser heat exchanger, wherein a first catalytic stage of the catalytic stages is configured to receive the process gas.

25. The system of claim 17, comprising:
catalytic stages to convert hydrogen sulfide and sulfur dioxide in the process gas into elemental sulfur and remove elemental sulfur to give a second process gas comprising hydrogen gas generated in the steam reforming, wherein the catalytic stages each comprise a catalytic converter and a condenser heat exchanger;
a hydrogenation reactor to hydrogenate sulfur dioxide in the second process gas into hydrogen sulfide to give a third process gas comprising the hydrogen sulfide formed in the hydrogenation reactor and hydrogen gas generated in the steam reforming;
a quench tower to quench the third process gas with water to remove water vapor from the third process gas and discharge an overhead gas comprising hydrogen gas generated in the steam reforming to an absorber column; and
the absorber column configured to absorb hydrogen sulfide from the overhead gas from the quench tower into liquid amine to give an overhead stream from the absorber column comprising hydrogen gas from the steam reforming as product.

26. The system of claim 17, comprising a quench tower to quench the process gas with water to remove water vapor from the process gas and discharge an overhead gas comprising hydrogen gas generated in the steam reforming to an absorber column as product.
